(19) United States
(12) Patent Application Publication
(10) Pub. No.: US 2023/0083946 A1
(43) Pub. Date: Mar. 16, 2023

(54) Portable Water Filtration Device

(71) Applicant: The Source H2O IP Holdings, LLC, Centennial, CO (US)

(72) Inventor: Miguel Favorel, Centennial, CO (US)

(21) Appl. No.: 17/944,357

(22) Filed: Sep. 14, 2022

Related U.S. Application Data
(60) Provisional application No. 63/243,906, filed on Sep. 14, 2021.

(51) Int. Cl. B01D 61/08; B01D 61/02; C02F 1/44; C02F 1/32

(52) U.S. Cl. CPC B01D 61/08; B01D 61/0271; C02F 1/442; C02F 1/325; B01D 2313/243; B01D 2313/12; B01D 2313/18; B01D 2313/201; B01D 2313/365; B01D 2313/60; B01D 2317/025; C02F 2201/005; C02F 2201/009; C02F 2209/40; C02F 2209/44; C02F 2209/445; C02F 2209/42; C02F 2303/04; C02F 2103/007

(57) ABSTRACT

The disclosed technology includes a water filtration unit. A disclosed water filtration unit includes a filtration unit housing defining a filtration unit cavity; an inlet coupled to the filtration unit housing; a pump positioned at least partially within the filtration unit cavity and including a pump inlet and pump outlet, the pump inlet coupled to the inlet; a filter housing positioned at least partially within the filtration unit cavity and including a filter inlet and filter outlet, the filter inlet coupled to the pump outlet and filter outlet coupled to a water dispenser; and a power source in communication with the pump to power the pump to push water through the filter housing when the water filtration unit is coupled to a water source.

### CROSS REFERENCE TO RELATED APPLICATIONS

The present application claims the benefit of priority to U.S. Provisional Patent Application No. 63/243,906, entitled “Portable Water Filtration Device,” filed Sep. 14, 2021, the entirety of which is hereby incorporated by reference herein for all purposes.

### TECHNICAL FIELD

The technology described herein relates generally to filtration devices, specifically to portable filtration devices.

### BACKGROUND

When people go on long outdoor adventures, such as camping, fishing, hunting, and the like, or lengthy road trips, they often bring plastic water bottles to stay hydrated. Plastic water bottles are often problematic as they provide only a limited supply of drinking water and are wasteful and harmful to the environment. Plastic waste is an ongoing problem, with landfills receiving 27 million tons of plastic in 2018. Plastic bottles can take 450 years or more to decompose, leaving an abundance of plastic waste.

Some people use reusable water jugs or coolers as an alternative to disposable plastics, but these containers also only provide a limited supply of clean drinking water. Further, they are often cumbersome, and it can be difficult to access the spout to dispense water. For example, many conventional jugs or coolers include a spout that is fixed on a bottom area of the jug or cooler. To dispense water, the spout needs to be clear of any surfaces or objects, which requires moving the entire jug or cooler.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes a water filtration unit. Embodiments of the present disclosure may include a water filtration unit including a filtration unit housing defining a filtration unit cavity. An inlet may be coupled to the filtration unit housing. A pump may be positioned at least partially within the filtration unit cavity and may include a pump inlet and pump outlet. The pump inlet may be coupled to the inlet. A filter housing may be positioned at least partially within the filtration unit cavity and may include a filter inlet and filter outlet. The filter inlet may be coupled to the pump outlet. A water dispenser may be coupled to the filter outlet. A power source may be in communication with the pump to power the pump to push water through the filter housing when the water filtration unit is coupled to a water source.

Other examples or embodiments of the present disclosure may include a water filtration unit for a dirty water reservoir. The water filtration unit may include a water filtration unit housing defining a filtration unit cavity. A pump may be positioned at least partially within the filtration unit cavity. A power source may be in electrical communication with the pump. A water dispenser may be coupled to an outer surface of the water filtration unit housing. An inlet may be coupled to the water filtration unit housing and configured to couple to a reservoir outlet of the dirty water reservoir. A filter housing may be in fluid communication with the pump and the water dispenser and configured to house a filter. Activation of the pump by the power source may pull dirty water from the dirty water reservoir when the inlet is coupled to the reservoir outlet and may push the dirty water to the filter housing. Filtered water may be pushed from the filter housing to the water dispenser by the activated pump when the filter is positioned within the filter housing.

Further examples or embodiments of the present disclosure may include a water filtration reservoir including a reservoir including a reservoir housing defining a reservoir cavity, and a reservoir outlet coupled to the reservoir housing. A water filtration unit may be coupled to the reservoir. The water filtration unit may include a filtration unit housing defining a filtration unit cavity. An inlet may be coupled to the filtration unit housing. A pump may be positioned at least partially within the filtration unit cavity and may include a pump inlet and pump outlet. The pump inlet may be coupled to the inlet. A filter housing may be positioned at least partially within the filtration unit cavity and may include a filter inlet and filter outlet. The filter inlet may be coupled to the pump outlet. A water dispenser may be coupled to the filter outlet. A power source may be in communication with the pump to power the pump to push water through the filter housing from the reservoir. The water filtration unit may be aligned with the reservoir such that the inlet is biased against the reservoir outlet, allowing water to flow from the reservoir to the water filtration unit when the pump is activated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a rear isometric view of a portable water filtration device or water filtration unit.

FIG. 2 is an exploded isometric view of the water filtration unit of FIG. 1.

FIG. 3 is a rear elevation view of the water filtration unit of FIG. 1 with the rear wall of the filtration unit housing removed.

FIG. 4 is a bottom isometric view of the filtration unit housing of the water filtration unit of FIG. 1.

FIG. 5 is a cross section view of the filtration unit housing of FIG. 4 taken along line 5-5.

FIG. 6 is a zoomed in top isometric view of the water dispenser cavity of the water filtration unit of FIG. 1.

FIG. 7 is a zoomed in top plan view of the water dispenser cavity of FIG. 6 housing a water dispenser.

FIG. 8 is a front elevation view of an alternate embodiment of a water dispenser and water dispenser cavity.

FIGS. 9A-B are zoomed in front elevation views of exemplary user inputs and outputs that can be included with the water filtration unit of FIG. 1.

FIG. 10 is a rear isometric view of the filter housing of the water filtration unit of FIG. 1.

FIG. 11 is an isometric view of a filter housing lid that can be included with the filter housing of FIG. 10.

FIG. 12 is a cross section view of the inlet valve of FIG. 3 taken along line 12-12.

FIG. 13 is a rear isometric view of the water filtration unit of FIG. 1 showing placement of an exemplary filter in the filter housing.

FIG. 14A is a rear isometric view of the water filtration unit of FIG. 3 showing a first exemplary positioning of connectors and flow of water between the inlets and outlets within the filtration unit cavity.

FIG. 14B is a rear isometric view of an alternate embodiment of the water filtration unit of FIG. 3 showing a second exemplary positioning of connectors and flow of water between the inlets and outlets within the filtration unit cavity.

FIG. 15 is a simplified block structure for computing devices that may be integrated into the water filtration unit of FIG. 1.

FIG. 16 is an isometric view of an exemplary reservoir that can be used with the water filtration unit of FIG. 1.

FIG. 17 is a top plan view of the reservoir of FIG. 16.

FIG. 18 is a cross section view of the reservoir of FIG. 16 taken along line 18-18.

FIG. 19 is a partially exploded isometric view of an exemplary water filtration reservoir.

FIG. 20 is a partially exploded right side elevation view of the water filtration reservoir of FIG. 19.

FIG. 21 is an isometric view of the water filtration reservoir of FIG. 19 in an assembled configuration.

FIG. 22 is a top plan view of the water filtration reservoir of FIG. 21.

FIG. 23 is an isometric view of another embodiment of a water filtration reservoir.

FIG. 24 is an isometric view of the water filtration reservoir of FIG. 23 with the filter access panel in an open position.

FIG. 25 is a cross section view of the water filtration reservoir of FIG. 23 taken along line 25-25.

FIG. 26 a partially exploded right side elevation view of the water filtration reservoir of FIG. 23 with the water filtration unit detached from the reservoir.

FIG. 27 is a zoomed in rear isometric view of the water filtration unit of FIG. 26.

### DETAILED DESCRIPTION

This disclosure is related to a portable water filtration device. In several embodiments, the portable water filtration device is attachable to a water reservoir. The portable water filtration device may include an inlet that allows water from the water reservoir to flow therethrough when the portable water filtration device is coupled to the water reservoir. In several embodiments, the portable water filtration device includes one or more filters, a pump, and a power source. In these embodiments, the pump, activated by the power source, is configured to pull water from a water reservoir or water source and push the water through the one or more filters to produce drinking water. The portable water filtration device may include a sanitized spout for dispensing the drinking water.

Water is necessary for human survival. Drinking water can prevent dehydration, a condition that can cause unclear thinking, mood change, overheating, constipation, and kidney stones. When people are out in the wilderness, such as camping, fishing, hunting, and the like, they may not have access to drinking water. Often times in these circumstances, people bring disposable plastic water bottles or jugs or reusable water jugs or coolers filled with a fixed amount of water. However, these portable sources of drinking water are wasteful, harmful to the environment, and/or may be inadequately stocked (e.g., run out of water before the trip is over). A portable water filtration device of the present disclosure is capable of filtering water from various water sources, including, for example, rivers, streams, creeks, ponds, lakes, tap water, and the like, to provide a limitless supply of portable drinking water while reducing the waste and harmful environmental effects of disposable plastic bottles.

While certain reusable water bottles have filtration capabilities, these water bottles require human power to filter the water stored therein. For example, certain water bottles can be filled with a dirty water source, e.g., river water, and the water is filtered by a user sucking and squeezing the bottle to push the water through a filter before it enters the user's mouth. Further, such water bottles only provide a single, personal sized serving of water. In several embodiments disclosed herein, a portable water filtration device includes a power source to facilitate water filtration without the need for human power. In several embodiments, a portable water filtration device includes a battery-powered pump to facilitate water filtration. A disclosed portable water filtration device is capable of filtering water from a large reservoir to continuously provide filtered water that can be used for various purposes, such as hydrating a group of people, cleaning dishes, washing hands, and the like, providing greater quantities of filtered water than that produced by current portable water filtration devices.

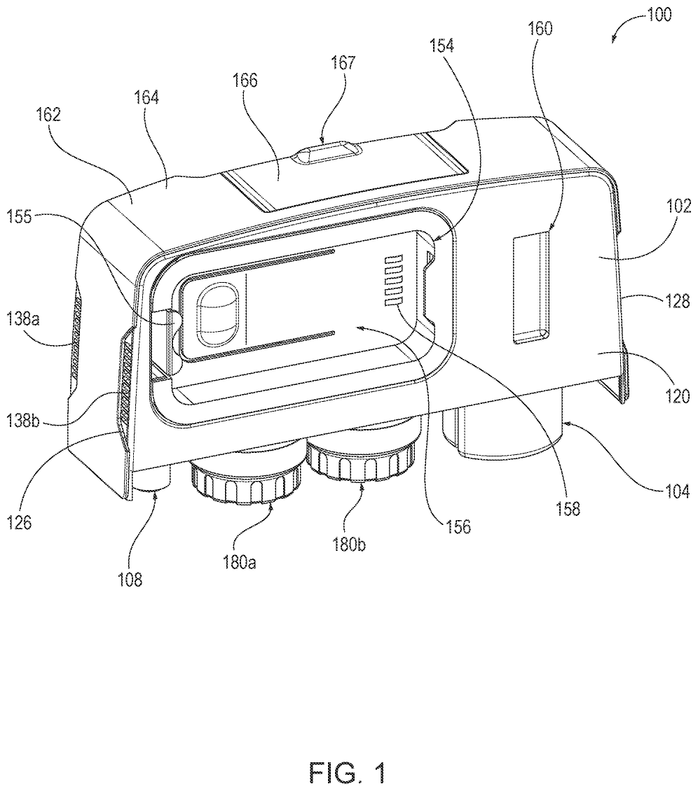

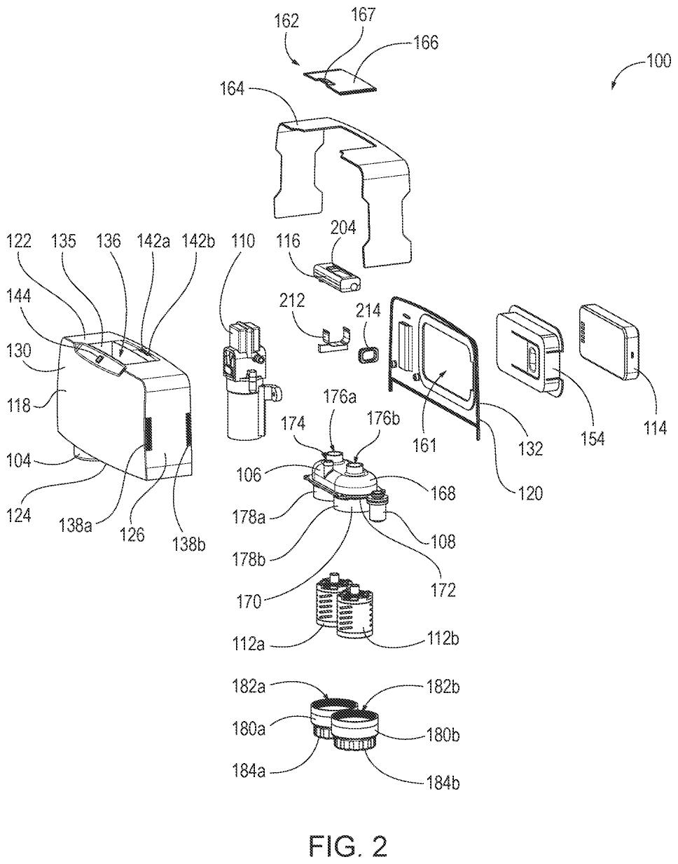

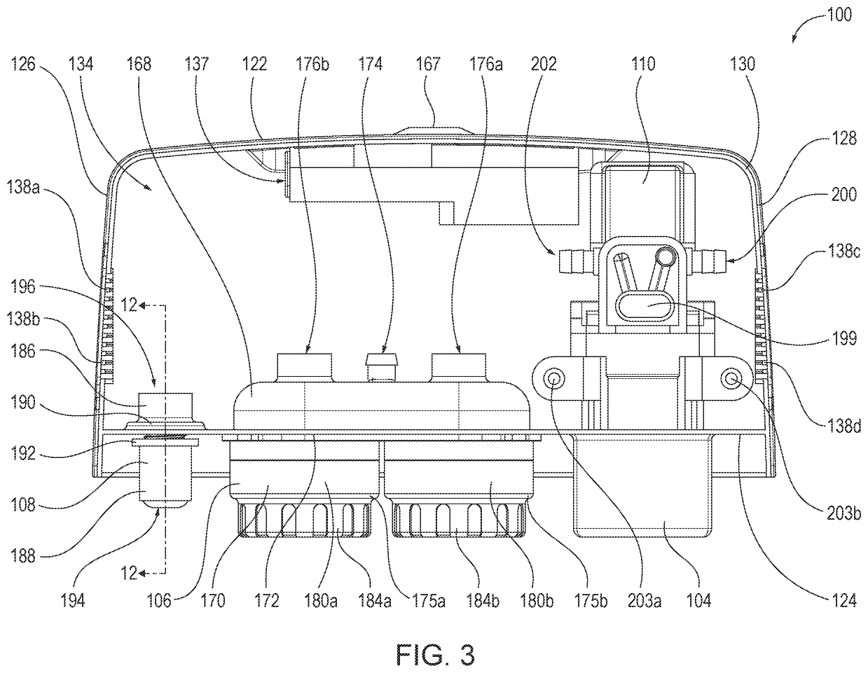

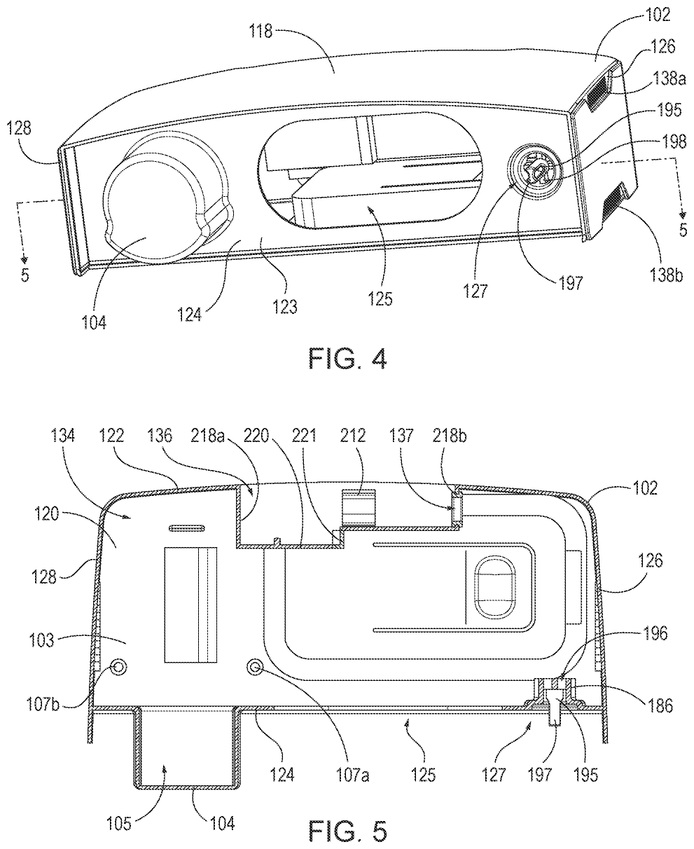

Turning to the figures, portable water filtration device embodiments of the present disclosure will now be discussed in more detail. FIG. 1 is a rear isometric view of a portable water filtration device or water filtration unit 100. FIG. 2 is an exploded isometric view of the water filtration unit 100 of FIG. 1. FIG. 3 is a rear view of the water filtration unit 100 of FIG. 1 with the rear wall of the filtration unit housing 102 removed. FIG. 4 is a bottom isometric view of the filtration unit housing 102. FIG. 5 is a cross section view of the filtration unit housing 102 of FIG. 4 taken along line 5-5. As shown in FIGS. 1-5, the water filtration unit 100 includes a filtration unit housing 102, a pump housing 104, a filter housing 106, an inlet valve 108, a pump 110, a first and second filter 112a, b, a power source 114, and a water dispenser 116.

As shown, the filtration unit housing 102 includes a front wall 118, a rear wall 120, a top wall 122, a bottom wall 124, a left sidewall 126, and a right sidewall 128. In the depicted example, the front wall 118, top wall 122, bottom wall 124, and left and right sidewalls 126, 128 form a first filtration unit housing component 130, and the rear wall 120 forms a second filtration unit housing component 132. While two filtration unit housing components are depicted, any number of housing components are contemplated to form the filtration unit housing 102. As shown in FIG. 3, the filtration unit housing 102 (e.g., the first filtration unit housing component 130) forms a filtration unit cavity 134.

As shown in FIGS. 4 and 5, the bottom wall 124 of the filtration unit housing 102 may include the pump housing 104, a filter housing aperture 125, an inlet valve aperture 127, and an inlet valve upper body 186. The pump housing 104 extends from a bottom surface 123 of the bottom wall 124 and defines a pump housing cavity 105. The pump housing cavity 105 may be shaped and sized to correspond with a shape and size of the pump 110, accommodating a pump 110 that is larger in height than the height of the left and right sidewalls 126, 128 of the filtration unit housing 102. In the depicted embodiment, the pump housing 104 has a generally cylindrical shape to correspond to the shape of the pump 110; however, other shapes are contemplated to correspond with different shaped pumps contemplated herein. While the pump housing 104 is depicted as integral with the filtration unit housing 102, forming a protrusion of the bottom wall 124, it is contemplated that the pump housing 104 may be a separate component coupled to the bottom wall 124. For example, the pump housing 104 may be received within or aligned with an aperture defined in the bottom wall 124, in a similar manner as the filter housing 106 described below. As shown in FIG. 5, a front surface 103 of the rear wall 120 may include pump mounts 107a, b (e.g., screws, bolts, apertures, etc.) positioned on either side of the pump housing 104 to hold the pump 110 in place when it is positioned within the pump housing 104.

The filter housing aperture 125 may be defined within the bottom wall 124. The filter housing aperture 125 is shaped and sized to correspond with a shape of the filter housing 106. For example, the filter housing aperture 125 may have a generally oval shape; however, other shapes are contemplated to correspond with different shaped filter housing, which may depend on the size, type, and number of filters used with the water filtration unit 100.

The inlet valve aperture 127 may be defined within the bottom surface 123 of the bottom wall 124 and is aligned with the inlet valve upper body 186 and inlet valve outlet 196. The inlet valve aperture 127 may be shaped and sized to correspond with an inlet valve lower body 188, as described in more detail below. For example, the inlet valve aperture 127 may have a circular shape. The inlet valve upper body 186 may protrude from the bottom wall 124 into the filtration unit cavity 134 and define an inlet valve outlet 196. The inlet valve outlet 196 may include an inlet valve attachment 195. The inlet valve attachment 195 may include intersecting bars 198 and a rod or stem 197. The intersecting bars 198 may form a cross and divide the inlet valve outlet 196 into four apertures. The rod or stem 197 may extend from an intersecting point of the intersecting bars 198 and out of the inlet valve aperture 127. The inlet valve attachment 195 may provide a sealing and locking mechanism for attaching an outlet of a reservoir, hose, faucet, tube, or the like. In this manner, the inlet valve attachment 195 may provide a universal attachment point for attaching to various water sources. In the depicted embodiment, the inlet valve aperture 127 and inlet valve upper body 186 are positioned proximate the left sidewall 126, the pump housing 104 is positioned proximate the right sidewall 128, and the filter housing aperture 125 is positioned between the inlet valve aperture 127 and pump housing 104; however, other arrangements are contemplated.

The filtration unit housing 102 may include a plurality of vents 138a, b, c, d. As shown, the vents 138a, b, c, d are positioned on the left and right sidewalls 126, 128. The vents 138a, b, c, d may be positioned centrally along a length of the respective sidewalls 126, 128. As shown, the vents 138a, b on the left sidewall 126 are positioned along opposing edges of the left sidewall 126, proximate the front wall 118 and rear wall 120, respectively. The vents 138c, d on the right sidewall 128 are similarly positioned. The vents 138a, b, c, d may be positioned to keep the water filtration housing 100 components (e.g., the power source 114 and pump 110) at a cool temperature to avoid overheating.

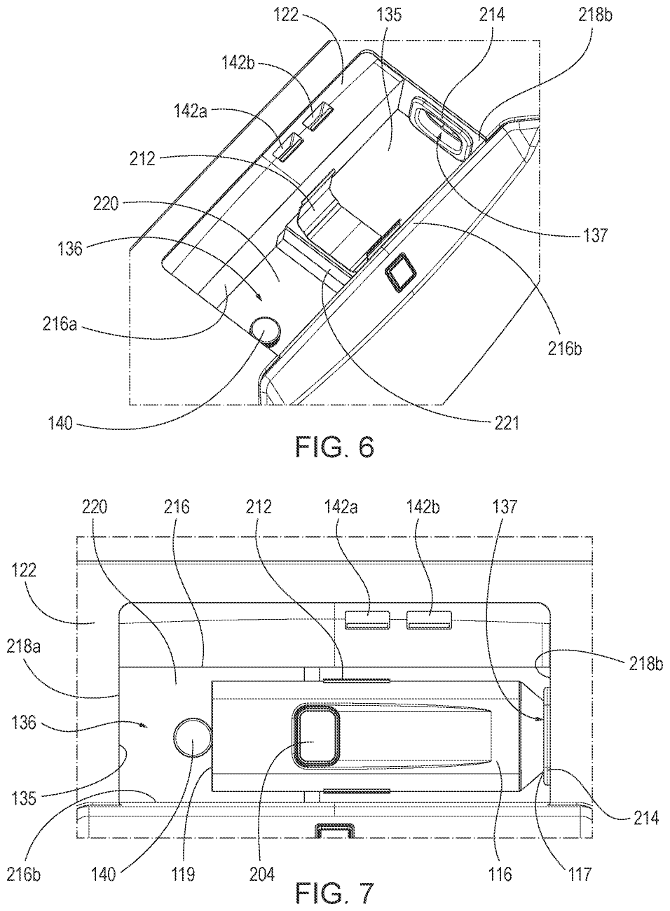

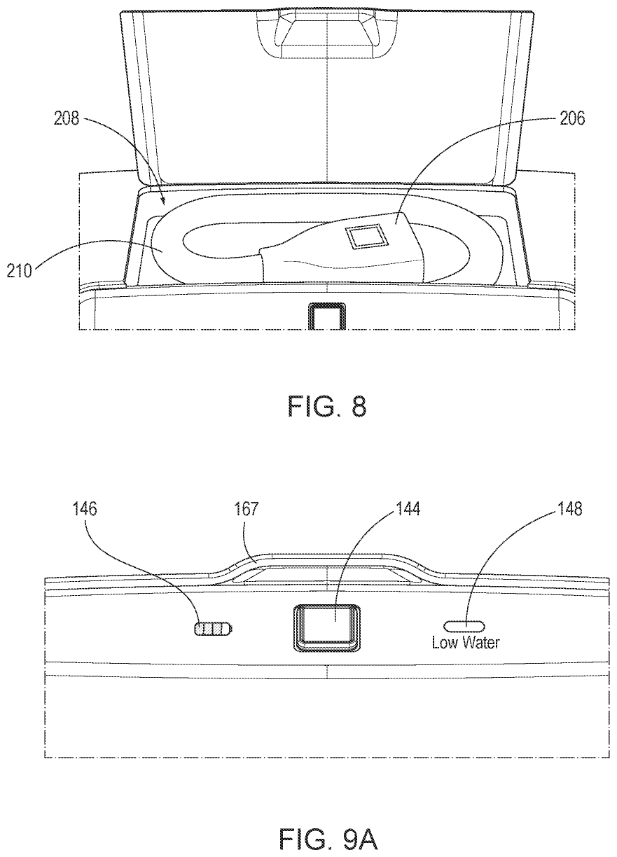

The filtration unit housing 102 may include a water dispenser cavity 136 for storing the water dispenser 116. As shown in FIG. 5, the water dispenser cavity 136 may be defined within the top wall 122 of the filtration unit housing 102. FIGS. 6-7 show zoomed in views of the water dispenser cavity 136. As shown, the water dispenser cavity 136 may be defined by dispenser cavity walls 135, including first and second length sidewalls 216a, b, first and second width sidewalls 218a, b, and a dispenser cavity bottom surface 220. The second width sidewall 218b may define a water dispenser cavity aperture 137 that provides an opening between the water dispenser cavity 136 and the filtration unit cavity 134. The dispenser cavity bottom surface 220 may include a step 221, such that a portion of the dispenser cavity bottom surface 220 closer to the first width sidewall 218a is positioned below or stepped down from (e.g., further from the top wall 122) a portion of the dispenser cavity bottom surface 220 closer to the second width sidewall 218b. The water dispenser cavity 136 may be shaped to fit a water dispenser (e.g., water dispenser 116 in FIG. 7 or water dispenser 206 in FIG. 8) and/or a water dispenser connector or extension (e.g., extension 210 in FIG. 8), such as a hose or tubing for example. As shown, the water dispenser cavity 136 has a generally rectangular shape (e.g., a rectangular opening); however, other shapes are contemplated to accommodate a shape of the water dispenser 116.

As shown in FIGS. 6-7, the water dispenser cavity 136 may house a dispenser sanitizer 140, such as an ultraviolet (UV) light. In the depicted embodiment, the dispenser sanitizer 140 is positioned on the stepped down portion of the dispenser cavity bottom surface 220 (e.g., closer to the first width sidewall 218a). The water dispenser cavity 136 may house a clip 212 to hold the water dispenser 116 in place. As shown, the clip 212 has a U-shape and is positioned along the dispenser cavity bottom surface 220 and the first and second length sidewalls 216a, b of the dispenser cavity 136. For example, the clip 212 may be positioned on the stepped up portion of the dispenser cavity bottom surface 220 (e.g., closer to the second width sidewall 218b). An O-ring 214 may be positioned within the water dispenser cavity 136 adjacent the second width sidewall 218b and around the water dispenser cavity aperture 137. The O-ring 214 may separate the water dispenser 116 from the second width sidewall 218b.

The filtration unit housing 102 may include one or more ports for coupling to one or more external devices. For example, the one or more ports may provide power to or receive power from the one or more external devices. As shown, the filtration unit housing 102 includes two USB ports 142a, b for coupling to external devices, such as, for example, mobile phones, computers, external power sources (e.g., batteries, solar power, etc.), and the like. The water filtration unit 100 may be used to charge external devices, such as a mobile phone. As shown, the USB ports 142a, b are positioned on the top wall 122.

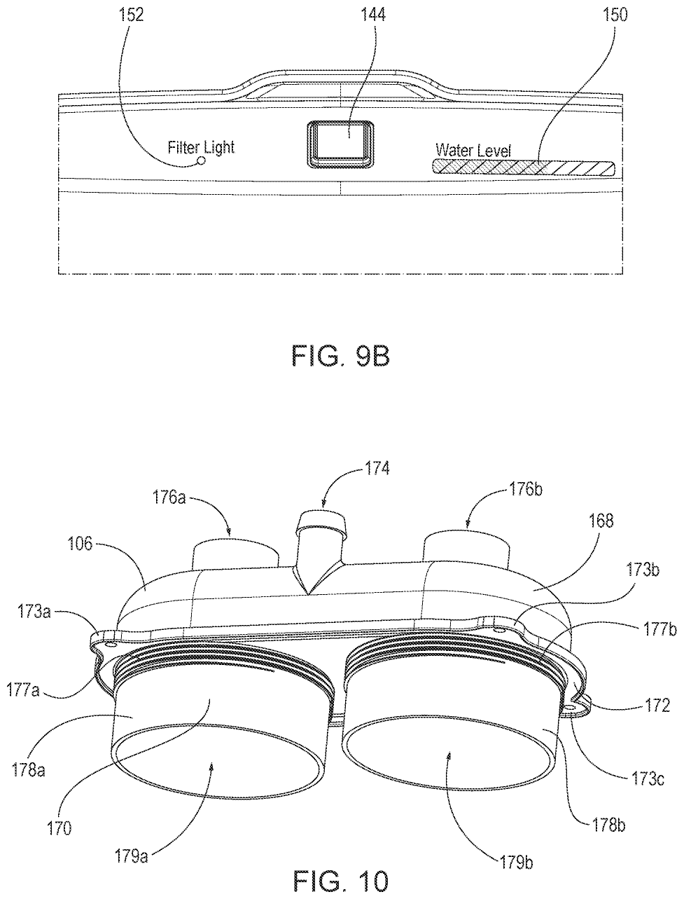

The filtration unit housing 102 may include one or more user inputs and/or outputs that allow a user to interact with the water filtration unit 100. FIGS. 9A-B show zoomed in views of exemplary user inputs and outputs. The user inputs and/or outputs may include a power switch 144, and one or more indicators showing a status of one or more internal components. As shown, the power switch 144 is a button; however, other switches are contemplated such as, for example, a toggle, switch, or the like.

The one or more indicators may include one or more of a power level indicator 146, a low water indicator 148, a water level indicator 150, and a filter life or status indicator 152. The power level indicator 146 may be coupled to a power source sensor that detects the power level of the power source 114. The power level indicator 146 displays the amount of power remaining. The low water indicator 148 or water level indicator 150 may be coupled to a water level sensor (e.g., a float sensor or switch) that detects the water level of a water reservoir coupled to the water filtration unit 100, as discussed in more detail below. The low water indicator 148 may be an LED light that turns on when the water in the water reservoir drops below a particular threshold (e.g., less than ⅕ of the reservoir capacity), indicating, for example, that the water is low and should be refilled. The LED light may change different colors depending on the level of water. For example, a green light may indicate a full or sufficient water level, a yellow light may indicate water level is getting low (e.g., approaching a particular threshold level) (e.g., half full), and a red light may indicate water level is low (e.g., has reached the particular threshold level) (e.g., a quarter full) and needs to be refilled. The water level indicator 150 may be a gauge that shows a level or percentage of water remaining in the water reservoir. As shown in FIG. 9B, the water level indicator 150 is a light bar. The filter life indicator 152 may be coupled to a filter sensor that detects filter function based on changes in water flow through one or both of the first and second filters 112a, b. As shown in FIG. 9B, the filter life indicator 152 is an LED light indicating filter status. For example, a green light may indicate a healthy, functioning filter; a yellow light may indicate the filter is still functioning but about to expire; and a red light may indicate the filter has expired, is no longer functioning properly, and should be replaced. In embodiments where multiple filters are included, it is contemplated that the filter life indicator 152 may specify which filter has expired. In some embodiments, a plurality of filter life indicators may be included that are associated with a plurality of filters. In these embodiments, the filter life indicators may be configured to indicate when an associated filter has expired.

As shown in FIGS. 1-2, the filtration unit housing 102 may include a power port 154 for coupling the water filtration unit 100 to power. In the depicted embodiment, the power port 154 is positioned on the rear wall 120 of the filtration unit housing 102. As shown in FIG. 2, the rear wall 120 may include a power port aperture 161 for receiving the power port 154. The power port aperture 161 may be shaped and sized to correspond with a shape and size of the power port 154. In the depicted embodiment, the power port aperture 161 has a generally rectangular shape. The longer edge of the power port aperture 161 may be parallel to the top and bottom walls 122, 124, such that the power port 154 is positioned horizontally on the rear wall 120. It is contemplated that the power port 154 may be integral with the rear wall 120 (and the power port aperture 161 omitted), e.g., a protrusion of the rear wall 120 into the filtration unit cavity 134.

The power port 154 may be shaped to couple with a power source 114 (e.g., a battery, solar panel, electrical plug, etc.). In the depicted embodiment, the power port 154 includes a power port cavity 156 for receiving the power source 114. For example, the power port cavity 156 may be a battery cavity shaped to fit a battery. As shown, the power port cavity 156 has a generally rectangular shape. In the depicted embodiment, the power port 154 includes a release mechanism 155 (e.g., a clip) to easily remove the power source 114 from the power port cavity 156 (e.g., remove a battery from a battery cavity). In the depicted embodiment, the power port cavity 156 includes a plurality of battery contacts 158 for drawing power from a battery inserted therein. Other shaped and sized power ports are contemplated depending on the power source. For example, it is contemplated that the power port may be an electrical port or cable that couples to an electric outlet.

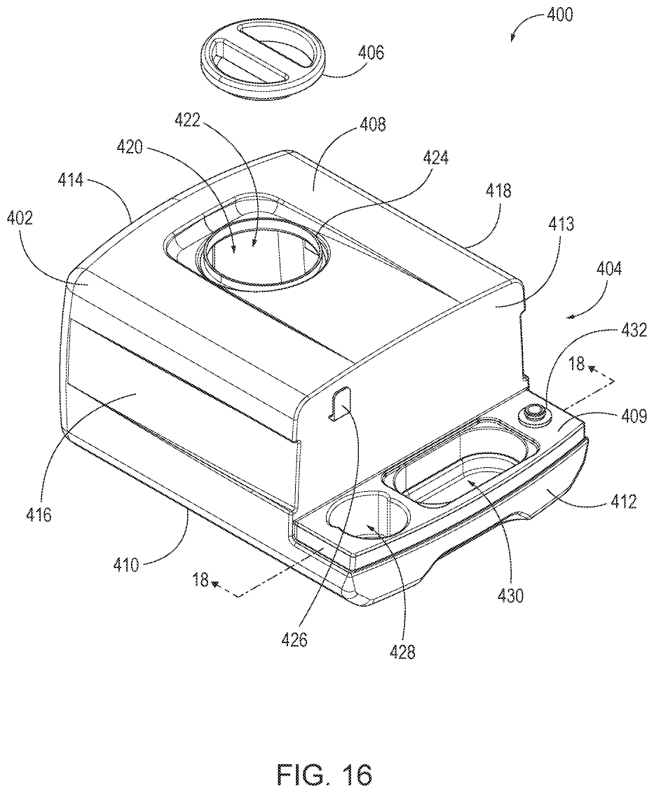

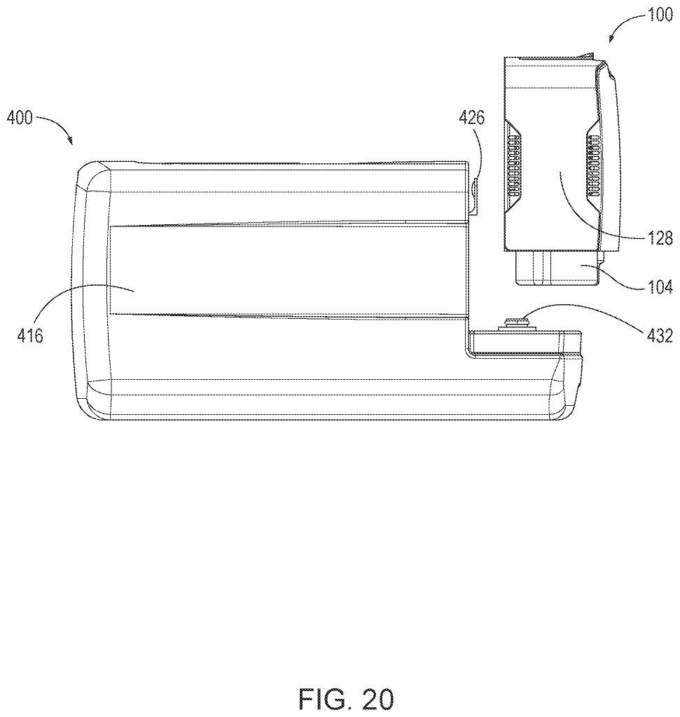

The filtration unit housing 102 may include a latch component or system 160. As shown, the latch component 160 is defined within the rear wall 120 of the filtration unit housing 102. The latch component 160 couples the water filtration unit 100 to a water reservoir, as discussed in more detail below. The latch component 160 may be shaped to correspond with a reservoir latch component on the water reservoir (e.g., reservoir latch component 426 described with respect to FIGS. 16-17 and 19-20) to couple with the reservoir latch component. In the depicted example, the latch component 160 is a substantially rectangular shaped recess that corresponds with a rectangular shaped latch on a water reservoir.

In some embodiments, the water filtration unit 100 may include a cover 162. As shown, the cover 162 is positioned on the top wall 122 and left and right sidewalls 126, 128 of the filtration unit housing 102. The cover 162 may include a cover body 164 and a lid 166. The lid 166 may include a raised lip 167 that enables a user to easily lift the lid 166. The lid 166 may be coupled to the cover body 164 by a hinge. It is contemplated that the cover 162 may be omitted and the lid 166 may couple to the top wall 122 of the filtration unit housing 102. The lid 166 may be sized to cover the water dispenser cavity 136.

While various components are depicted on certain walls of the filtration unit housing 102, it is contemplated that the components may be rearranged in different positions on the filtration unit housing 102. For example, while the water dispenser cavity 136 and ports 142a, b are positioned on the top wall 122, it is contemplated that the water dispenser cavity 136 and/or ports 142a, b may be positioned on the front or rear walls 118, 120 or left or right sidewalls 126, 128.

The water filtration unit 100 may include a filter housing 106. FIG. 10 shows a rear isometric view of the filter housing 106. As shown in FIGS. 2, 3, and 10, the filter housing 106 may include an upper body portion 168 and a lower body portion 170. A ridge or lip 172 may extend between the upper body portion 168 and the lower body portion 170 and beyond an outer surface of the upper and lower body portions 168, 170. As shown in FIG. 10, the lip 172 may include fastening means 173a, b, c, d (e.g., screws, nails, bolts, pins, etc., or apertures to receive the same) to couple the filter housing 106 to the filtration unit housing 102 (e.g., to the bottom wall 124). In the depicted embodiment, the upper body portion 168 includes an upper body cavity. The upper body portion 168 may include a filter housing inlet or filter inlet 174 and a first and second filter housing outlet or first and second filter outlet 176a, b. In the depicted embodiment, the filter inlet 174 and the first and second filter outlets 176a, b are positioned on a top surface of the upper body portion 168. As shown, the filter inlet 174 is positioned between the first and second filter outlets 176a, b. While two filter outlets 176a, b are depicted, the number of filter outlets may be selected to correspond to the number of filters, which may be varied as desired.

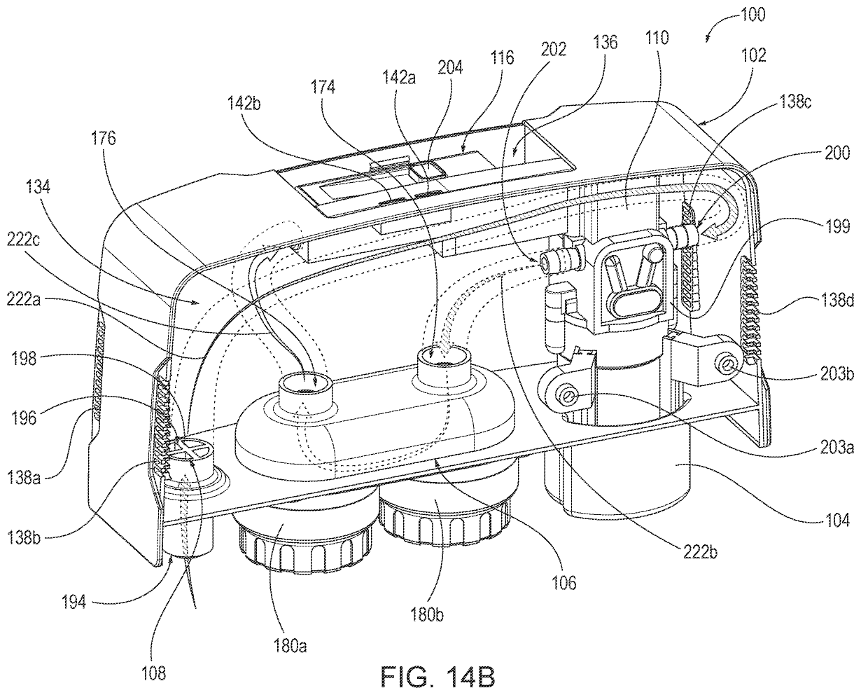

In some embodiments, one filter outlet may be included (with one or more filters). For example, in embodiments where water is filtered in line, as discussed in more detail below, a filter outlet may be positioned adjacent a filter of a plurality of filters. FIG. 14B shows an exemplary embodiment of a filter housing 106 that includes a single filter outlet 176. In this embodiment, the filter inlet 174 is positioned proximate a first filter stored in the filter housing 106 and the filter outlet 176 is positioned proximate a second filter stored in the filter housing 106. In the depicted embodiment, the filter inlet 174 and the filter outlet 176 are positioned on a top surface of the filter housing 106 (e.g., on a top surface of the upper body portion 168). The positioning of the filter outlet 176 relative to the filter inlet 174 may be such that water flows sequentially through the filters stored in the filter housing 106. It is contemplated that the positioning of the filter outlet 176 and filter inlet 174 may be varied and this functionality maintained. For example, the filter inlet 174 may be positioned on a side of the filter housing 106 closer to the pump 110. Additionally or separately, the filter outlet 176 may be positioned on a side of the filter housing 106 closer to the inlet valve 108.

In some embodiments with a plurality of filter outlets, the filter outlets may include adjustable outlet valves that can be positioned in an open or closed position to change the flow of water through the filter housing 106. For example, one filter outlet may be in a closed position to allow water to flow sequentially (or in line) through each filter. As another example, two or more filter outlets may be in an open position to allow water to flow simultaneously through two or more corresponding filters.

Returning to FIGS. 2, 3, and 10, in the depicted embodiment, the lower body portion 170 of the filter housing 106 includes a first and second filter housing unit 178a, b. As shown, the first and second filter housing units 178a, b have a generally cylindrical shape and define a first and second lower body cavity 179a, b, respectively. As shown in FIG. 10, the first and second filter housing units 178a, b include threading 177a, b adjacent the ridge 172.

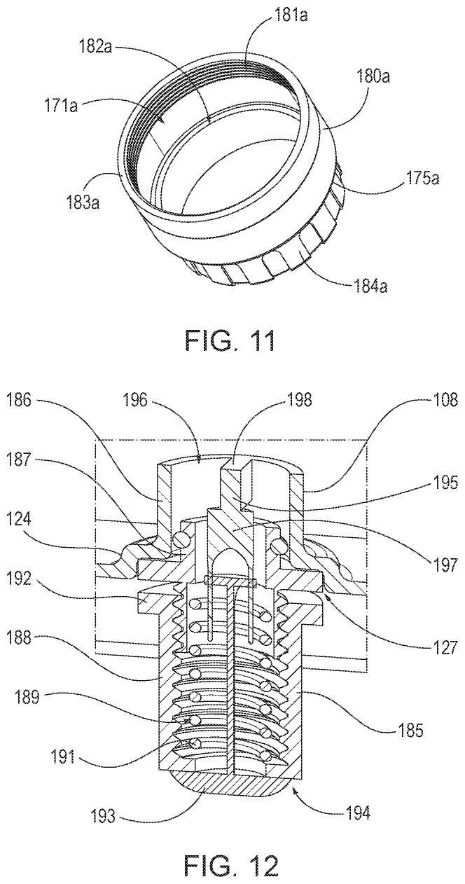

The filter housing 106 may include first and second filter housing lids 180a, b that couple to the first and second filter housing units 178a, b, respectively, sealing the respective first and second lower body cavities 179a, b. The first and second filter housing lids 180a, b may be shaped to correspond with a shape of the first and second filter housing units 178a, b. For example, the first and second filter housing lids 180a, b may have a generally cylindrical shape. FIG. 11 shows an isometric view of the first filter housing lid 180a. As shown, the first filter housing lid 180a defines a lid cavity 182a. The filter housing lid 180a has a lid opening 171a at a first lid end 183a and a ridged surface 184a at a second lid end. The lid cavity 182a may receive a portion of a filter stored in the first lower body cavity 179a. The ridged surface 184a may facilitate gripping of the first filter housing lid 180a by a user. The first filter housing lid 180a may include a first filter housing lid lip 175a, such that the ridged surface 184a has a smaller circumference than the remainder of the first filter housing lid 180a. The first lid end 183a may include first filter housing lid threading 181a on an internal surface of the first filter housing lid 180a. The second filter housing lid 180b includes the same features as shown for the first housing lid 180a in FIG. 11, specifically a second filter housing lid cavity 182b, a second filter housing lid ridged surface 184b, a second filter housing lid lip 175b, and second filter housing lid threading 181b.

The first and second housing lids 180a, b may be coupled to the first and second filter housing units 178a, b by coupling the first and second filter housing lid threading 181a, b to the threading 177a, b of the first and second filter housing units 178a, b. The first and second filter housing lids 180a, b may be removable to replace filters stored in the respective first and second lower body cavities 179a, b.

The filter housing 106 and the seals formed between the first and second filter housing lids 180a, b and first and second filter housing units 178a, b, respectively, are leak proof to prevent water from leaking out of the filter housing 106, ensuring that water passing through the filter housing 106 contacts the filters and exits the filter housing 106 through the first and second filter outlets 176a, b as clean drinking water.

The water filtration unit 100 may include an inlet valve 108. FIG. 12 shows a cross section view of the inlet valve 108 of FIG. 3 taken along line 12-12. The inlet valve 108 may be any valve capable of having a closed configuration, preventing fluid flow therethrough, and an open configuration, allowing fluid flow therethrough (e.g., a globe valve). In the depicted embodiment, the inlet valve 108 includes an inlet valve upper body 186 and an inlet valve lower body 188. As discussed above with respect to the filtration unit housing 102, the inlet valve upper body 186 may protrude from the bottom wall 124 of the filtration unit housing 102 into the filtration unit cavity 134 and define an inlet valve outlet 196. The inlet valve outlet 196 may include an inlet valve attachment 195, including intersecting bars 198 and a rod or stem 197. The intersecting bars 198 may form a cross and may divide the inlet valve outlet 196 into four apertures. The rod or stem 197 may extend from an intersecting point of the intersecting bars 198 and out of the inlet valve aperture 127. The inlet valve lower body 188 may include a spring housing 185, a coupling means 187, a lower inlet valve lip or ridge 192, an inlet valve inlet 194, an inlet valve seal or plug 193, and a spring 191. The spring housing 185 may define an inlet valve lower body cavity 189 that houses the spring 191. The spring housing 185 may include a lower inlet valve lip or ridge 192. The inlet valve lower body 188 may be received within the inlet valve aperture 127 and couple to the inlet valve upper body 186. As shown, the coupling means 187 is received within the inlet valve aperture 127 and couples to the inlet valve upper body 186 and rod 197. As shown, the inlet valve 108 may have a generally cylindrical shape. While an inlet valve 108 is depicted, it is contemplated that the valve may be omitted and instead an inlet included that allows water to consistently flow therethrough (e.g., without a closed configuration).

In several embodiments, the water filtration unit 100 includes a pump 110. The pump 110 may be any marine style pump or water pump that pumps at a pressure sufficient to produce safe drinking water (e.g., to filter toxins and bacteria out of pond or river water) while providing a satisfactory user experience. The pump 110 may include a motor that pushes water through the water filtration unit 100 at a certain pressure and flow rate. For example, the pump 110 operates at a pressure that pushes water at a particular flow rate through the first and second filter 112a, b for filtration. The more contact time between the water and the filters 112a, b, the greater the removal of toxins, microorganisms, and other particles from the water. Certain lower water flow rates are therefore desirable for greater contact time and adequate filtration. However, higher water flow rates may be more desirable for a satisfactory user experience. The pump 110 may operate at a pressure that accounts for these opposing goals.

For example, the pressure may be sufficient for effective nanofiltration. As an example, the pressure may be sufficient to produce a flow rate through two nano filters that is sufficient to produce drinking water from river water. As another example, the pressure may be sufficient to pass water through a filter at a rate that removes 99.99% of bacteria from the water. For example, the pump 110 may operate at a pressure of 2 psi or greater. In several embodiments, the pressure of the pump 110 is selected to also account for user experience. For example, the pressure may produce a flow rate at the water dispenser 116 that is desirable for quick water retrieval (e.g., 2 gallons per minute). In one embodiment, the pump 110 operates at a pressure between about 30 psi to about 40 psi (e.g., 35 psi). In several embodiments, the pump 110 is powered by a portable power source, such as, for example, a battery, solar power, or the like.

In the depicted embodiment, the pump 110 includes a pump body 199, pump inlet 200, and pump outlet 202. The pump body 199 may have a generally cylindrical shape. The pump inlet 200 and pump outlet 202 may extend from opposing sides of the pump body 199 and perpendicular to the pump body 199. The pump 110 may include pump mounting brackets 203a, b for mounting the pump 110 to a surface of the filtration unit housing 102 to secure the pump 110 in place within the filtration unit cavity 134. For example, the pump mounting brackets 203a, b may be coupled to the pump mounts 107a, b to couple the pump 110 to the rear wall 120 of the filtration unit housing 102.

In some embodiments, the water filtration unit 100 includes a first and second filter 112a, b. It is contemplated that any type of filter capable of removing toxins (e.g., chlorine), microorganisms (e.g., giardia and other waterborne parasites and bacteria), and other particles from water may be used with the water filtration unit 100, including for example, nano, cation, anion, carbon, activated carbon, granular activated carbon, activated alumina, bone char, catalytic, kinetic degradation fluxion (KDF), calcite, and the like. In several embodiments, the first and second filter 112a, b are nano filters. It is contemplated that the first and second filter 112a, b may be the same type or different types of filters. While two filters are depicted, it is contemplated that any number of filters may be used with the water filtration unit 100, such as one filter or three or more filters. For example, more or less filters may be contemplated based on the type of filters used and the desired level of filtration. For example, two filters may be desirable to filter river borne bacteria. In the depicted embodiment, two filters 112a, b are used with a pump 110 that operates at a pressure between 30 psi to 40 psi to remove 99.99% of bacteria and toxins from water flowing therethrough.

In several embodiments, the water filtration unit 100 includes a power source 114. For example, the power source 114 may be any conventional power source, such as a battery, solar power source (e.g., cell), or other portable power source. The power source 114 may be rechargeable, such as a rechargeable battery for example. While the depicted embodiment includes a portable power source 114, it is contemplated that the power source may be an external electrical power source. The power source 114 may provide between 10.2-13.6V. In some embodiments, the power source 114 provides 12V or about 2.1 amps of power.

In several embodiments, the water filtration unit 100 includes a water dispenser 116. FIG. 7 shows a zoomed in view of a water dispenser 116 stored in the water dispenser cavity 136. The water dispenser 116 may be a spigot, spout, faucet, tap, and the like. In the depicted embodiment, the water dispenser 116 has a rectangular shape that corresponds to the rectangular shape of the water dispenser cavity 136. The water dispenser 116 may have a dispenser inlet end 117 (e.g., where water flows into the water dispenser 116) and a dispenser outlet end 119 (e.g., where water flows out the water dispenser 116).

The water dispenser 116 may have an extension, such as a tube or hose, that allows a user to remove the water dispenser 116 from the water dispenser cavity 136 to dispense water. In the depicted embodiment, the extension may be stored in the filtration unit cavity 134 and may extend through the water dispenser cavity aperture 137 to enable the water dispenser 116 to be removed from the water dispenser cavity 136. By having an extendable water dispenser 116, water can be dispensed from the water filtration unit 100 without needing to reposition the water filtration unit 100. For example, if the water filtration unit 100 is in an inconvenient location (e.g., in a trunk), water may still be accessed via the water dispenser 116. The extendable water dispenser 116 provides an advantage over current water jugs/coolers that have a fixed water dispenser on a lower portion of the water jug/cooler, which often requires the water jug/cooler to be repositioned to access the water dispenser. The extendable water dispenser 116 of the present disclosure is more convenient and accessible, improving the user experience.

FIG. 8 shows an alternate embodiment of a water dispenser 206 stored in a water dispenser cavity 208, similar to the water dispenser cavity 136 discussed with respect to FIGS. 5-7. As shown in FIG. 8, the water dispenser 206 includes an extension 210 (e.g., tubing) that allows the water dispenser 206 to be removed from the water dispenser cavity 208, facilitating access to water. In this embodiment, both the water dispenser 206 and extension 210 are stored in the water dispenser cavity 208.

As shown, the water dispenser 116 may include an ON/OFF mechanism 204 (e.g., a button or toggle). When activated (e.g., turned ON), the ON/OFF mechanism allows water to flow through the water dispenser 116. When deactivated (e.g., turned OFF), water flow ceases.

An assembled water filtration unit 100 will now be described in more detail. As shown in FIG. 1, in its assembled configuration, the second filtration unit housing component 132 may be coupled to the first filtration unit housing component 130 to partially seal the filtration unit cavity 134. The second filtration unit housing component 132 may be coupled to the first filtration unit housing component 130 such that the rear wall 120 is parallel to the front wall 118, forming the filtration unit housing 102. The power port 154 may be positioned within the power port aperture 161 on the rear wall 120 of the filtration unit housing 102, such that the power port cavity 156 is recessed in the rear wall 120. The power source 114 (e.g., battery) may be received within the power port cavity 156 such that the power source 114 contacts the plurality of battery contacts 158.

The water dispenser 116 may be positioned within the water dispenser cavity 136 and held in place by the clip 212. As shown in FIG. 7, the water dispenser 116 is positioned proximate the second width sidewall 218b such that the dispenser inlet end 117 is separated from the second width sidewall 218b by the O-ring 214. The dispenser outlet end 119 may be positioned proximate the dispenser sanitizer 140. The dispenser outlet end 119 may be positioned vertically above the dispenser sanitizer 140 (e.g., due to the step 221).

The cover 162 may be coupled to the filtration unit housing 102. As shown, the cover body 164 is positioned on the top wall 122 and left and right sidewalls 126, 128 of the filtration unit housing 102. The lid 166 may be coupled to the cover body 164 by a hinge and covers the water dispenser cavity 136 and water dispenser 116 when in the closed position. It is contemplated that the cover 162 may be omitted and the lid 166 may couple to the top wall 122 of the filtration unit housing 102.

In the assembled configuration, the inlet valve 108 may be coupled to the bottom wall 124 of the filtration unit housing 102. As shown in FIGS. 3 and 12, the inlet valve lower body 188 may be received within the inlet valve aperture 127 and couple to the inlet valve upper body 186. As shown, the coupling means 187 is received within the inlet valve aperture 127 and couples to the inlet valve upper body 186 and rod 197. As shown, the inlet valve upper body 186 is positioned within the filtration unit cavity 134 and the inlet valve lower body 188 is positioned outside the filtration unit housing 102. In this configuration, the pathway from the inlet valve inlet 194 to the inlet valve outlet 196 is perpendicular to the bottom wall 124.

The filter housing 106 may be coupled to the bottom wall 124 of the filtration unit housing 102. As shown, the filter housing 106 is positioned within the filter housing aperture 125 defined within the bottom wall 124. As shown, the upper body portion 168 is positioned within the filtration unit cavity 134, and the lower body portion 170 is positioned outside the filtration unit housing 102, with the ridge or lip 172 positioned adjacent the bottom wall 124. In this configuration, the filter inlet 174 and first and second filter outlets 176a, b are positioned perpendicular to the bottom wall 124. As shown, the first and second filter housing lids 180a, b are coupled to the first and second filter housing units 178a, b, respectively, sealing the respective lower body cavities 179a, b of the filter housing 106. In the sealed position, the filter housing lids 180a, b are positioned adjacent the ridge or lip 172. The first and second filter housing lids 180a, b may be removable to place filters in the lower body cavities 179a, b.

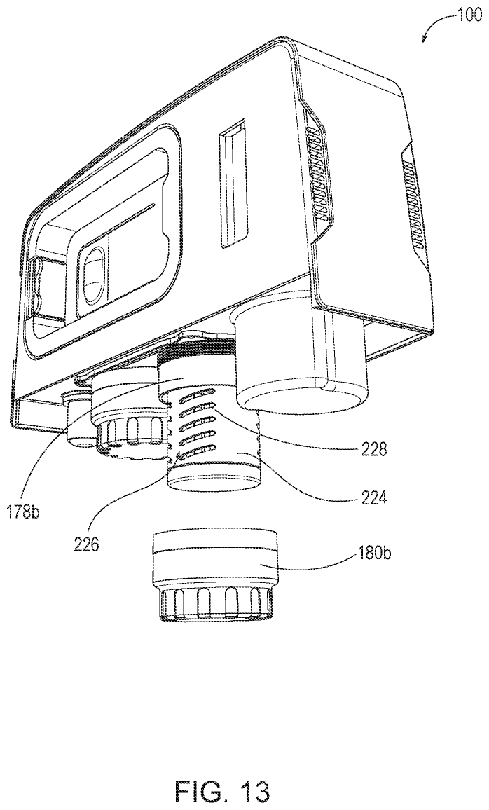

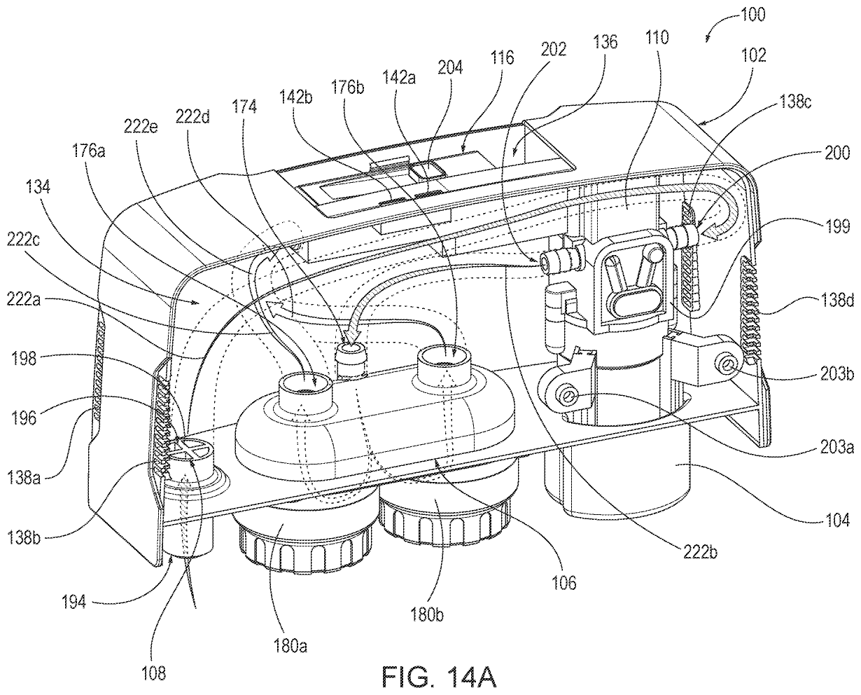

FIG. 13 shows an exemplary filter 224 positioned in the filter housing 106. As shown, the second filter housing lid 180b is removed from the second filter housing unit 178b and the filter 224 is partially positioned in the lower body cavity 179b of the second filter housing unit 178b. The filter 224 may be a conventional filter, as described in more detail above. As shown, the filter 224 includes a plurality of slits 226 to allow water to flow therethrough and contact the filter material 228 stored within the filter 224. The filter material 228 may be a conventional filter material, such as, for example, active carbon. The second filter housing lid 180b may be coupled to the second filter housing unit 178b to seal the filter 224 in the filter housing 106.

The pump 110 may be partially received within the pump housing cavity 105 formed by the pump housing 104. As shown in FIG. 3, the pump 110 is positioned within the filtration unit cavity 134 such that the pump inlet 200 and pump outlet 202 are closer to the top wall 122 than the bottom wall 124 of the filtration unit housing 102. As shown, the pump inlet 200 and pump outlet 202 are positioned vertically above and perpendicular to the inlet valve outlet 196, the filter inlet 174, and the first and second filter outlets 176a, b. The pump 110 may be coupled to the rear wall 120 of the filtration unit housing 102 by the pump mounting brackets 203a, b (e.g., via screws or other fastening means coupled to the pump mounting brackets 203a, b).

The inlets and outlets of the inlet valve 108, filter housing 106, and pump housing 104 may be coupled by a plurality of hollow connectors, including for example, tubing, hoses, pipes, and the like. FIG. 14A shows exemplary positioning of connectors (depicted in dashed lines) between the inlets and outlets within the filtration unit cavity 134. As shown, a first connector 222a couples the inlet valve outlet 196 to the pump inlet 200, a second connector 222b couples the pump outlet 202 to the filter inlet 174, a third connector 222c couples the first filter outlet 176a to the water dispenser 116, and a fourth connector 222d couples the second filter outlet 176b to the water dispenser 116. The third connector 222c and fourth connector 222d may be coupled to a fifth connector 222e that couples to the water dispenser 116. The fifth connector 222e may pass through the water dispenser cavity aperture 137 to couple with the dispenser inlet end 117 of the water dispenser 116. For example, the fifth connector 222e may be the water dispenser connector or extension (e.g., extension 210 in FIG. 8) that couples to the water dispenser 116 and allows the water dispenser 116 to be pulled away from the filtration unit housing 102. Alternatively, the fifth connector 222e may be a separate component from the water dispenser extension and may couple to the water dispenser extension.

FIG. 14B shows another exemplary positioning of connectors between the inlets and outlets within the filtration unit cavity 134. In this embodiment, a first connector 222a couples the inlet valve outlet 196 to the pump inlet 200, a second connector 222b couples the pump outlet 202 to the filter inlet 174, and a third connector 222c couples the filter outlet 176 to the water dispenser 116.

It is contemplated that the various components may be coupled by fastening means (e.g., screws, bolts, nails, adhesive, etc.), soldering, welding, and the like. While certain components are described as a single component, it is contemplated that they may be made of various parts coupled together. For example, the walls 118, 122, 124, 126, 128 that make up the first filtration unit housing component 130 may be separate components coupled together. Similarly, while certain components are described as separate components, it is contemplated that they may be a single part. For example, it is contemplated that the power port 154 may be integral with the rear wall 120; for example, the power port cavity 156 may be defined in the rear wall 120.

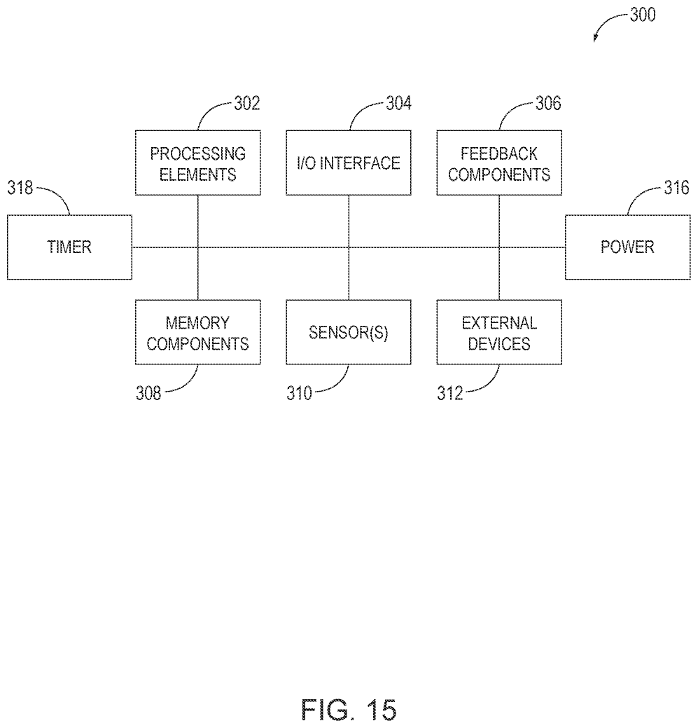

A simplified block structure for computing devices that may be integrated into the water filtration unit 100 and/or the water filtration reservoir 500 discussed in more detail below is shown in FIG. 15. As shown, the computing device 300 may include one or more processing elements 302, an input/output interface 304, feedback components 306, one or more memory components 308, one or more sensors 310, one or more external devices 312, a power source 316, and a timer 318. Each of the various components may be in communication with one another through one or more busses, wireless means, or the like.

The local processing element 302 is any type of electronic device capable of processing, receiving, and/or transmitting instructions. For example, the local processing element 302 may be a central processing unit, microprocessor, processor, or microcontroller. Additionally, it should be noted that select components of the computing device 300 may be controlled by a first processor and other components may be controlled by a second processor, where the first and second processors may or may not be in communication with each other.

The one or more memory components 308 are used by the computing device 300 to store instructions for the local processing element 302, as well as store data, such as timing data, filter health data, water quality data, battery life data, total dissolved solids (TDS) data, UV light life data, power data, and the like. The one or more memory components 308 may be, for example, magneto-optical storage, read-only memory, random access memory, erasable programmable memory, flash memory, or a combination of one or more types of memory components.

The one or more feedback components 306 provide visual, haptic, and/or auditory feedback to a user. For example, the one or more feedback components may include a display that provides visual feedback to a user and, optionally, can act as an input element to enable a user to control, manipulate, and calibrate various components of the computing device 300. The display may be a liquid crystal display, plasma display, organic light-emitting diode display, and/or cathode ray tube display. In embodiments where the display is used as an input, the display may include one or more touch or input sensors, such as capacitive touch sensors, resistive grid, or the like. As another example, the one or more feedback components 306 may include a light (e.g., LED), an alarm or alert sound, a vibration, and the like.

The I/O interface 304 allows a user to enter data into the computing device 300, as well as provides an input/output for the computing device 300 to communicate with other devices. The I/O interface 304 can include one or more input buttons, touch pads, and so on.

The one or more sensors 310 may include, for example, one or more pressure sensors, motion sensors, water sensors (e.g., a float switch), energy sensors, flow sensors, water quality sensors, and the like. For example, a pressure sensor may detect pressure relief at the water dispenser 116, e.g., indicating water flow. As another example, a pressure sensor may detect pressure of the lid 166 on the top wall 122 of the filtration unit housing 102. As another example, an energy sensor may detect an energy level of the power source 114. As another example, a flow sensor may detect a flow rate through a filter, e.g., indicating filter life/expiration. As yet another example, a float sensor may detect a water level in a reservoir (e.g., reservoir 400 of FIGS. 16-22) coupled to the water filtration unit 100.

The external devices 312 are one or more devices that can be used to provide various inputs to the computing device 300, e.g., remote, keyboard, trackpad, or the like. The external devices 312 may be local or remote and may vary as desired.

The power source 316 is used to provide power to the computing device 300, e.g., battery, solar panel, or the like. The power source 316 may be the same as the power source 114 described with respect to FIG. 2. In some embodiments, the power source 316 is rechargeable; for example, contact and contactless recharge capabilities are contemplated. In some embodiments, the power source 316 is a constant power management feed. In other embodiments, the power source 316 is intermittent (e.g., controlled by a power switch or activated by an external signal). The power source 316 may include an auxiliary power source.

The timer 318 may be used to track time. For example, the timer 318 may track time for automated shut-off of one or more water filtration unit 100 components. For example, the pump 110 may be automatically shut off after a period of time of non-use (e.g., after 1-2 minutes). For example, it may be beneficial to have the pump 110 in an ON and standby mode in between back-to-back uses of the water dispenser 116 to quickly dispense water for each use. For example, if a user wants to fill a water bottle directly after another user, the pump 110 may remain ON in between uses (e.g., when the ON/OFF mechanism 204 is deactivated) so that the second user does not have to wait for the pump 110 to warm up and reactivate. However, after a period of time, it may be desirable to have the pump 110 automatically shut off to avoid over-heating and destruction of the pump 110. As another example, the dispenser sanitizer 140 (e.g., UV light) may be automatically shut off after a period of time. For example, the dispenser sanitizer 140 may be activated to sanitize the water dispenser 116 when the water dispenser 116 is stored and the lid 166 is closed. After a period of time sufficient for sanitation (e.g., 1-2 minutes), the dispenser sanitizer 140 may be deactivated to conserve energy.

With reference to FIGS. 1-15, in operation, the power switch 144 may be activated (e.g., the button is pushed by a user) to power on the water filtration unit 100. When the water filtration unit 100 is powered on, the pump 110 may be activated or in a ready/standby state or mode (e.g., ready to pump water on command). The lid 166 may be pulled into an open position, e.g., by a user placing one or more fingers under the raised lip 167. The water dispenser 116 may be pulled out of the water dispenser cavity 136, e.g., via a water dispenser extension (e.g., extension 210 in FIG. 8), and the ON/OFF mechanism 204 may be activated (e.g., by a user pushing a button) to initiate water flow. In embodiments where the pump 110 is in a ready/standby mode when the water filtration unit 100 is powered on, activation of the ON/OFF mechanism 204 may activate the pump 110 to enter operation mode and to begin pumping water through the water filtration unit 100. In embodiments where the pump 110 is activated by the power switch 144 and the water filtration unit 100 is in a pressurized state, activation of the ON/OFF mechanism 204 initiates water flow out the water dispenser 116.

When in operation mode, the pump 110 pulls water from a reservoir or water source via the inlet valve 108 and pushes the water through the water filtration unit 100. FIG. 14A shows an example of water flowing through the water filtration unit 100. As shown, water flows from the water reservoir or source through the inlet valve inlet 194, out the inlet valve outlet 196, to the pump inlet 200 (e.g., via the first connector 222a), through the pump 110, out the pump outlet 202, to the filter housing inlet 174 (e.g., via the second connector 222b), through the filter housing 106 and filters stored therein (e.g., simultaneously through both filters), out the first and second filter outlets 176a, b, and to the water dispenser 116 (e.g., via the third, fourth, and fifth connectors 222c, d, e) where water is dispensed. The water may be dispensed, for example, to fill one or more water bottles, rinse or wash hands or objects, and the like. In several embodiments, water flowing through the system prior to flowing through the filter housing 106 and filters stored therein may be dirty water, and water flowing out the first and second filter outlets 176a, b to the water dispenser 116 is clean, filtered, drinking water.

In some embodiments, water may flow through the filter housing 106 in a single direction, passing through the filters stored therein in an in-line or sequential fashion. FIG. 14B shows an example of water flowing through the water filtration unit 100 in an in-line fashion. As shown, water flows from the pump outlet 202 to the filter housing inlet 174 (e.g., via the second connector 222b). Water flows into the filter housing 106 through the filter housing inlet 174, through the first filter, then through a second filter stored in the filter housing 106, and finally out the single filter housing outlet 176 and to the water dispenser 116 (e.g., via the third connector 222c).

In several embodiments, the water is filtered sequentially by a plurality of filters (e.g., as shown in FIG. 14B). The water passing out of the filter housing may be twice (or more) filtered water. It is contemplated that the filters may filter the same or different substances. The filters used may vary based on the type of water being filtered. For example, filters used for river water may be different than those used for lake water to filter different substances or toxins. It is contemplated that filtering through a first filter may improve filtering by a second filter. For example, the first filter may filter out substances that interfere with the second filter's filtration. As an example, chlorine can interfere with ion exchange. In this example, a first filter may filter out chlorine prior to a second filter preforming ion exchange and removing nitrates. By filtering out chlorine before the second filter performs ion exchange, the second filter may be more effective and may remove a greater percentage of nitrate than if chlorine was present. In some embodiments, both simultaneous and sequential filtration are contemplated, depending on the settings of the water filtration unit 100.

Once the desired amount of water has been dispensed, the ON/OFF mechanism 204 may be deactivated (e.g., by a user releasing a button), deactivating the water dispenser 116 (e.g., ceasing water flow therethrough). Upon deactivation of the water dispenser 116, the pump 110 may remain in the ready/standby state or mode for a period of time and automatically shutoff after the period of time has lapsed. Deactivation of the water dispenser 116 may be determined by a processing element 302 in communication with a sensor 310, such as a flow or pressure sensor. For example, a flow sensor may detect no flow out the water dispenser 116 or a pressure sensor may detect an increase in pressure at the water dispenser 116 output, indicating the water dispenser 116 has been deactivated. The processing element 302 may receive a dispenser deactivation signal (e.g., no or reduced flow or increased pressure) from the sensor 310, detect deactivation of the water dispenser (e.g., a zero or reduced flow state) based on the received signal, and determine a period of time to keep the pump 110 in standby mode. For example, the processing element 302 may initiate a timer 318 when deactivation (e.g., the zero flow state) is detected, and deactivate the pump 110 after a predetermined amount of time has passed. In some embodiments, it is contemplated that the pump 110 may turn off automatically when the ON/OFF mechanism 204 is deactivated.

The water dispenser 116 may be stored in the water dispenser cavity 136 and the lid 166 may be placed in the closed position, sealing the water dispenser 116 in the water dispenser cavity 136. A sensor 310 (e.g., a pressure or motion sensor) may detect when the lid 166 is in the closed position. A processing element 302 may receive a lid closed signal from the sensor 310 and activate the dispenser sanitizer 140 (e.g., turn on the UV light) and a timer 318. The dispenser sanitizer 140 may remain activated for a period of time (e.g., 1-2 minutes) to sanitize the water dispenser 116. The processing element 302 may determine the period of time has been reached via the timer 318 and deactivate the dispenser sanitizer 140 (e.g., turn off the UV light).

The water filtration unit 100 may be configured to couple to different types of water reservoirs and/or water sources. For example, the water filtration unit 100 may be coupled to a water cooler, jug, or basin. As another example, the water filtration unit 100 may couple to a water source, such as a river, lake, pond, or the like (e.g., by a connector such as a tube or hose).

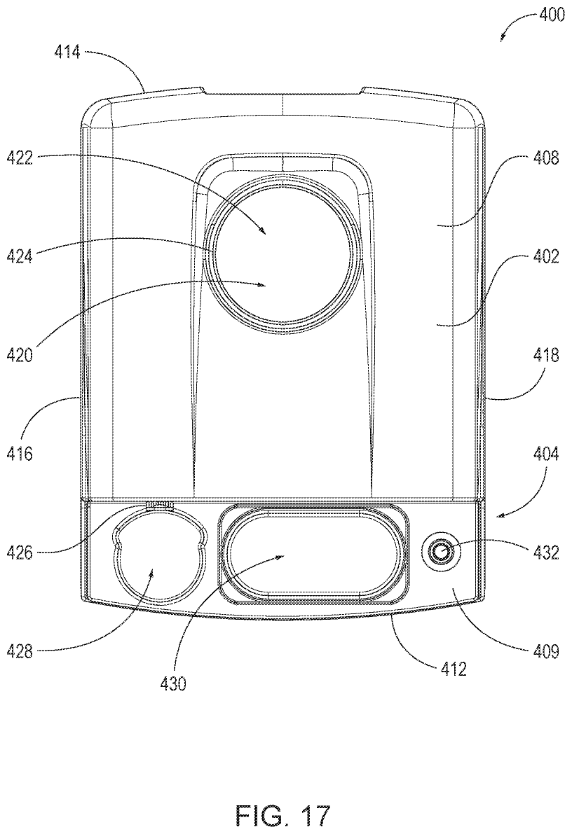

FIGS. 16-18 show an exemplary water reservoir that can be used with the water filtration unit 100 described with respect to FIGS. 1-15. As shown in FIGS. 16 and 17, the reservoir 400 includes a reservoir housing 402, a filtration unit receptacle 404, and a reservoir lid 406. The reservoir housing 402 includes a reservoir top wall 408, reservoir bottom wall 410, reservoir front wall 412, reservoir rear wall 414, reservoir right sidewall 416, and reservoir left sidewall 418. The reservoir top wall 408 may include a recessed top wall 409 (e.g., that is positioned closer to the reservoir bottom wall 410) and the reservoir front wall 412 may include a recessed front wall 413 (e.g., that is positioned closer to the reservoir rear wall 414). The reservoir walls 408, 409, 410, 412, 413, 414, 416, 418 may define a reservoir cavity 420.

As shown, the reservoir top wall 408 includes a water fill opening 422. In the depicted embodiment, the water fill opening 422 has a circular shape; however, other shapes are contemplated. The water fill opening 422 may be sized to fit a user's hand and/or arm. For example, the water fill opening 422 may allow a user to reach into the reservoir cavity 420, e.g., to clean inside the reservoir 400. For example, the water fill opening 422 may be 4″ in diameter or greater. A lid securing mechanism 424 may further define the water fill opening 422. The lid securing mechanism 424 may be a ring around the water fill opening 422. As shown, the lid securing mechanism 424 is raised from the reservoir top wall 408, forming a ridge. The lid securing mechanism 424 may include threading to couple with threading on the reservoir lid 406.

The filtration unit receptacle 404 may include a reservoir latch component 426, a pump housing receptacle 428, a filter housing receptacle 430, and a reservoir outlet valve 432. The filtration unit receptacle 404 may be defined by the recessed top wall 409 and the recessed front wall 413 of the reservoir housing 402. The filtration unit receptacle 404 may be shaped and sized to receive the water filtration unit 100. For example, the filtration unit receptacle 404 may have a depth defined by the distance between the reservoir front wall 412 and the recessed front wall 413 that corresponds to a width of the water filtration unit 100, the width defined by the distance between the front wall 118 and rear wall 120. The filtration unit receptacle 404 may further have a height defined by the distance between the reservoir top wall 408 and recessed top wall 409 that corresponds to a water filtration unit 100 height defined by the distanced between the top wall 122 and bottom wall 124.

As shown, the reservoir latch component 426 is coupled to the recessed front wall 413. In the depicted embodiment, the reservoir latch component 426 forms a hook that extends from the recessed front wall 413. Other shapes of the reservoir latch component 426 are contemplated to correspond with a shape of the latch component 160 of the filtration unit housing 102.

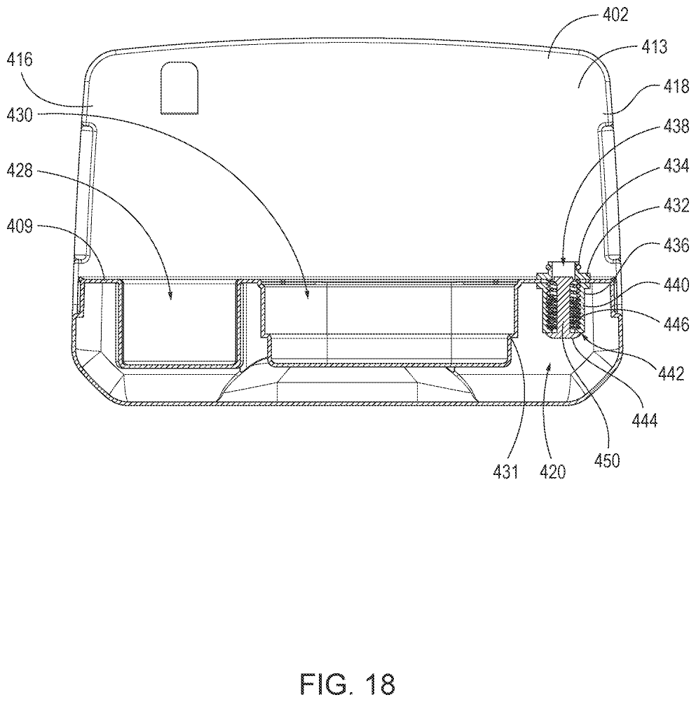

FIG. 18 shows a cross section view of the reservoir 400 of FIG. 16 taken along line 18-18. In the depicted embodiment, the pump housing receptacle 428 and filter housing receptacle 430 are defined in the recessed top wall 409. As shown, the pump housing receptacle 428 is positioned closer to the reservoir right sidewall 416, while the filter housing receptacle 430 is positioned more centrally within the recessed top wall 409. The shape of the pump housing receptacle 428 may correspond to a shape of the pump housing 104. For example, the pump housing receptacle 428 may have a generally circular cross section. The shape of the filter housing receptacle 430 may correspond to a shape of the filter housing 106. For example, the filter housing receptacle 430 may have a generally oval cross section to accommodate the first and second filter housing units 178a, b. As shown, the filter housing receptacle 430 may include a filter housing receptacle lip 431 that may correspond to a lip on the filter housing 106 (e.g., the first and second filter housing lid lips 175a, b).

The reservoir outlet valve 432 may be positioned on an opposite side of the filter housing receptacle 430 than the pump housing receptacle 428. For example, as shown, the reservoir outlet valve 432 is positioned closer to the reservoir left sidewall 418. The reservoir outlet valve 432 may have a shape that corresponds to a shape of the inlet valve 108 of the filtration unit housing 102. The reservoir outlet valve 432 may be any valve capable of having a closed orientation, preventing fluid flow therethrough, and an open orientation, allowing fluid flow therethrough (e.g., a globe valve). In the depicted embodiment, the reservoir outlet valve 432 includes a reservoir outlet valve upper body 434 and a reservoir outlet valve lower body 436. The reservoir outlet valve upper body 434 may protrude from the recessed top wall 409 and define a reservoir outlet valve outlet 438. The reservoir outlet valve lower body 436 may include a reservoir spring housing 440, a reservoir outlet valve inlet 442, a reservoir outlet valve seal or plug 444, and a reservoir outlet valve spring 446. The reservoir spring housing 440 may define a reservoir outlet valve lower body cavity 448 that houses the reservoir outlet valve spring 446. A reservoir inlet rod or stem 450 may be received within the reservoir outlet valve lower body cavity 448 and couple to the reservoir outlet valve seal or plug 444. The reservoir outlet valve lower body 436 may couple to the reservoir outlet valve upper body 434. As shown, the reservoir outlet valve 432 may have a generally cylindrical shape. The reservoir outlet valve 432 may be in a closed position when uncoupled to the water filtration unit 100, preventing water from escaping the reservoir 400 and may be in an open position when coupled to the water filtration unit 100, allowing water to flow therethrough. While a reservoir outlet valve 432 is depicted, it is contemplated that the valve may be omitted and instead an outlet included that has a single open configuration (e.g., no closed configuration). In these embodiments, a cap or lid may be included to cover the reservoir outlet when the reservoir 400 is not coupled to the water filtration unit 100.

The reservoir 400 may be sized to store water for multiple uses (e.g., more than a one-time or personal use such as that provided by a water bottle). For example, the reservoir cavity 420 may store an amount of water that is typical of water coolers/jugs, e.g., 5 gallons of water. The reservoir 400 may be used to store dirty water that is converted to clean drinking water by the water filtration unit 100. For example, any water may be stored in the reservoir 400, e.g., water from a faucet, river, creek, stream, pond, lake, and the like.

The reservoir housing 402 may be made of an antimicrobial or antibacterial material to prevent damage and/or mold growth from dirty water stored within the reservoir cavity 420. As an example, the reservoir housing 402 material may be nano silver embedded. For example, the reservoir housing 402 may be made of food grade plastic (e.g., BPA/BPS free) with nano-silver embedded into the plastic. It is contemplated that the reservoir housing 402 may include a sanitizer stored within the reservoir cavity 420 that is similar to the dispenser sanitizer 140 (e.g., a UV light) to sanitize the reservoir housing 402. The reservoir housing 402 material may be insulated to keep the reservoir housing 402 cool in the sun; however, the insulation may be minimized to limit the weight of the reservoir 400. It is contemplated that the filtration unit housing 102 and/or cover 162 may be made of the same or similar materials as the reservoir 400 (e.g., plastic, aluminum, or other metals, etc.). In some embodiments, a neoprene cover may be placed over the reservoir 400 and/or water filtration unit 100 to insulate and prevent the components from freezing. The neoprene cover may be shaped and sized to correspond to a shape and size of the reservoir 400 and/or water filtration unit 100.

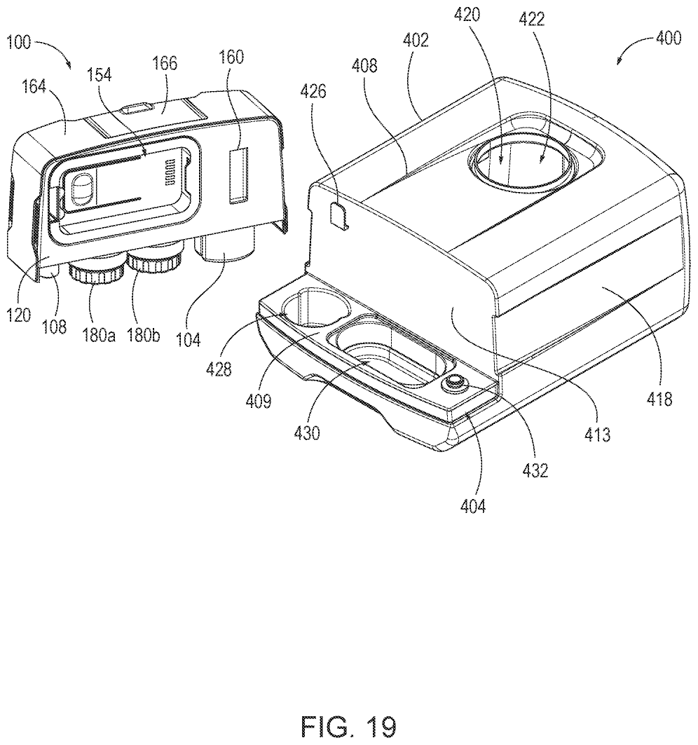

FIGS. 19-22 show an embodiment of an exemplary water filtration reservoir 500. As shown, the water filtration reservoir 500 includes the water filtration unit 100 coupled to the reservoir 400. The water filtration unit 100 may be positioned within the filtration unit receptacle 404 of the reservoir 400. The water filtration unit 100 may be aligned with the reservoir 400 such that the pump housing 104 is positioned within the pump housing receptacle 428, the filter housing 106 (e.g., the first and second filter housing units 178a, b) is positioned within the filter housing receptacle 430, the inlet valve 108 (or inlet) is biased against or couples to the reservoir outlet valve 432, and the latch component 160 couples to the reservoir latch component 426.

The pressure of the inlet valve 108 positioned on the reservoir outlet valve 432 opens one or both of the inlet valve 108 and reservoir outlet valve 432 creating a flow path therethrough, allowing water to flow from the reservoir 400, through the reservoir outlet valve 432 and inlet valve 108, and to the pump 110 via the first connector 222a, as discussed in more detail above. In the depicted embodiment, the reservoir outlet valve upper body 434 may push the inlet valve lower body 188 upward to contact the coupling means 187, moving the inlet valve lower body 188 away from the inlet valve seal 193, creating an opening at the inlet valve inlet 194 for water to flow therethrough. Pressure from the rod 197 and the inlet valve seal 193 on the reservoir inlet rod 450 may move the reservoir inlet rod 450 and reservoir outlet valve seal 444 relative to the reservoir spring housing 440 and partially into the reservoir cavity 420, creating an opening at the reservoir outlet valve inlet 442 for water to pass therethrough.

The water filtration unit 100 may be coupled to the reservoir 400 by the latch component 160. As discussed above, the latch component 160 may be shaped and sized to correspond with the reservoir latch component 426. For example, the reservoir latch component 426 may be a hook that is shaped to insert into the latch component 160 of the water filtration unit 100. However, other coupling means are contemplated to couple the water filtration unit 100 to the reservoir 400 and to allow the water filtration unit 100 to be removable from the reservoir 400.

In several embodiments, the water filtration unit 100 is removable or detachable from the reservoir 400. For example, the water filtration unit 100 may be removed to replace filters (e.g., filter 224 of FIG. 13). By removing the filter housing 106 from the filter housing receptacle 430, the filter housing 106 is accessible to remove the first and second filter housing lids 180a, b from the first and second filter housing units 178a, b, respectively, to replace one or more filters stored in the lower body cavities. As another example, the water filtration unit 100 may be removed to replace or recharge the power source 114 (e.g., battery). It is contemplated that the power source 114 may be recharged without removing the water filtration unit 100 from the reservoir 400. For example, the lid 166 may be placed in an open position and the power source 114 charged via one or more of the USB ports 142a, b. For example, an external power source (e.g., a battery, car charging outlet, solar panel, etc.) may be plugged into one or more of the USB ports 142a, b to charge the power source 114.

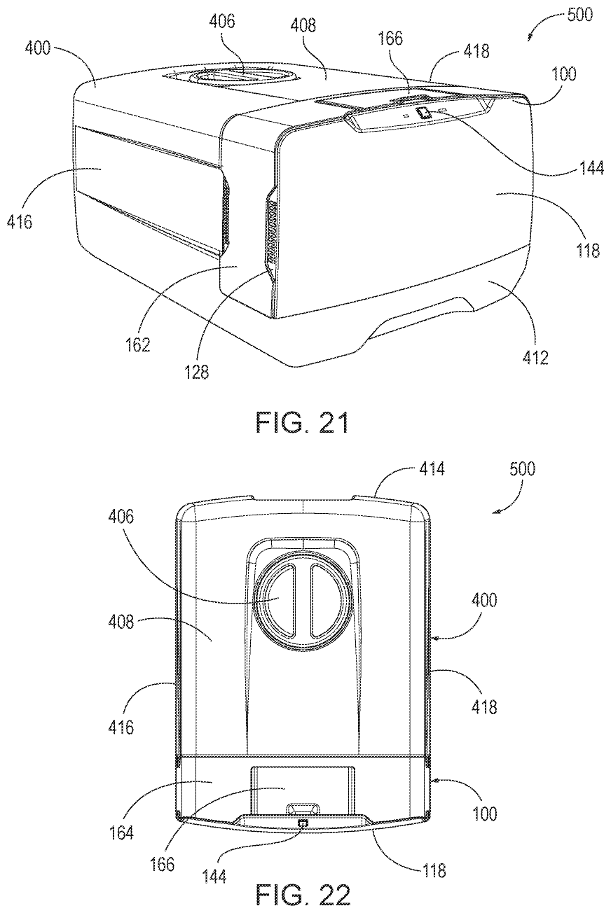

When the water filtration reservoir 500 is in an assembled configuration, the rear wall 120 of the water filtration unit 100 is adjacent the recessed front wall 413 of the reservoir 400 and the bottom wall 124 of the water filtration unit 100 is adjacent the recessed top wall 409 of the reservoir 400. As shown in FIGS. 21-22, in the assembled configuration, the front wall 118 of the water filtration unit 100 is substantially planar or flush with the reservoir front wall 412 and the cover 162 is substantially planar with the reservoir top wall 408, reservoir right sidewall 416, and reservoir left sidewall 418. In embodiments where the cover 162 is omitted, the reservoir top wall 408 may be substantially planar with the top wall 122, the reservoir right sidewall 416 may be substantially planar with the right sidewall 128, and the reservoir left sidewall 418 may be substantially planar with the left sidewall 126.

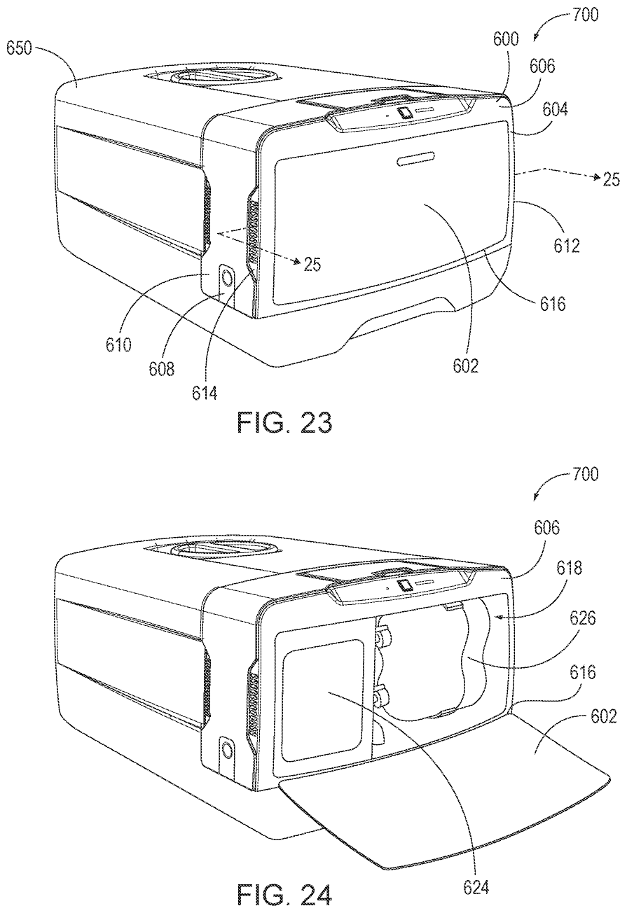

Other embodiments for a water filtration unit are envisioned. FIGS. 23-27 illustrate another embodiment of a water filtration unit 600 and water filtration reservoir 700. The features of the present embodiment have the same or similar structure and function as described above. In the present embodiment, the water filtration reservoir 700 includes a water filtration unit 600 coupled to a reservoir 650. The water filtration unit 600 may include a filter access panel 602 positioned on a front wall 604 of the filtration unit housing 606. As shown, the filter access panel 602 is coupled to the front wall 604 by a hinge positioned on a bottom edge 616 of the filter access panel 602 such that the filter access panel 602 can be pulled in a downward direction (e.g., towards a surface supporting the water filtration reservoir 700). However, it is contemplated that the hinge may be positioned on another edge of the filter access panel 602.

In the depicted embodiment, the water filtration unit 600 includes a latch release mechanism 608 positioned on a cover 610 of the water filtration unit 600. In embodiments where the cover 610 is omitted, the latch release mechanism 608 may be positioned on a left or right sidewall 612, 614, respectively, of the filtration unit housing 606. The latch release mechanism 608 may release the water filtration unit 600 from the reservoir 400. For example, the latch release mechanism 608 may be a button that releases a latch on the water filtration unit 600 (e.g., similar to latch 160 of water filtration unit 100) from a reservoir latch (e.g., reservoir latch component 426).

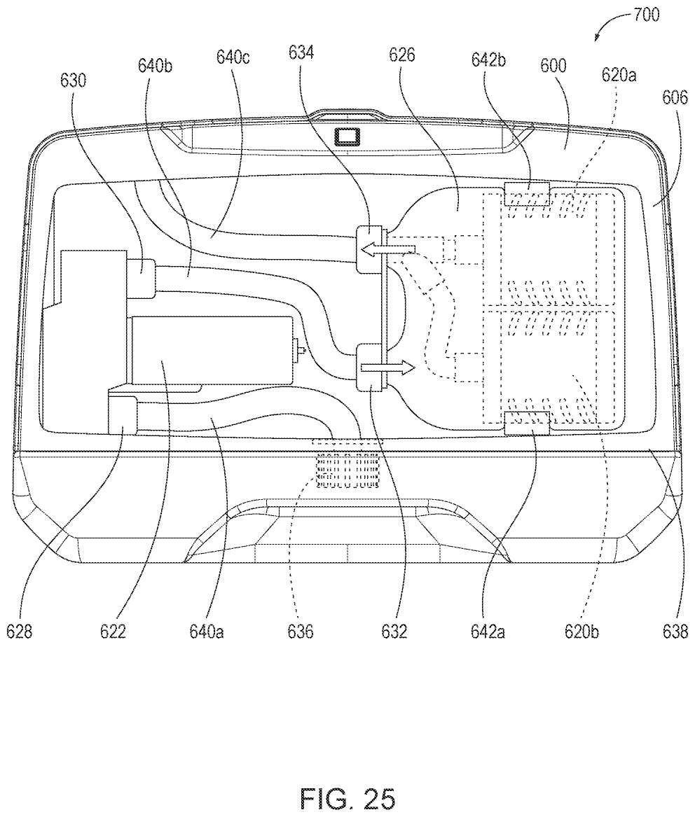

FIG. 24 shows the filter access panel 602 in an open position. As shown, the filtration unit housing 606 defines a filtration unit cavity 618 that is accessible by positioning the filter access panel 602 in the open position (e.g., via the hinge on the bottom edge 616). As shown in FIG. 25, the filtration unit housing 606 may store one or more filters 620a, b and a pump 622 within the filtration unit cavity 618. Returning to FIG. 24, the pump 622 may be covered or hidden from view by a concealing wall 624. The one or more filters 620a, b may be stored in a filter housing 626. The filter housing 626 may be coupled to the filtration unit housing 606 by fastening means 642a, b (e.g., clips). The filter housing 626 may be removable from the filtration unit cavity 618 by releasing the fastening means 642a, b, e.g., to replace the filters 620a, b.

With reference to FIG. 25, the pump 622 may include a pump inlet 628 and pump outlet 630. The pump inlet 628 may be positioned vertically below the pump outlet 630 (e.g., closer to a bottom wall 638 of the filtration unit housing 606). The filter housing 626 may include a filter inlet 632 and filter outlet 634. The filter inlet 632 may be positioned vertically below the filter outlet 634. As shown, the filter inlet 632 is positioned vertically below the pump outlet 630. The filter housing 626 may be removable from the filter inlet 632 and filter outlet 634 (e.g., via a threaded coupling) to remove the filter housing 626 from the filtration unit cavity 618, e.g., to replace the filters 620a, b. The water filtration unit 600 may include an inlet valve 636 coupled to the bottom wall 638 of the filtration unit housing 606. The pump inlet 628, pump outlet 630, filter inlet 632, and filter outlet 634 may be arranged perpendicular to the inlet or inlet valve 636 (e.g., water flows through them in a path/direction that is perpendicular to the path/direction of water flow through the inlet valve 636). The inlet valve 636 may be coupled to the pump inlet 628 by a first connector 640a. The pump outlet 630 may be coupled to the filter inlet 632 by a second connector 640b. The filter outlet 634 may be coupled to a water dispenser by a third connector 640c.

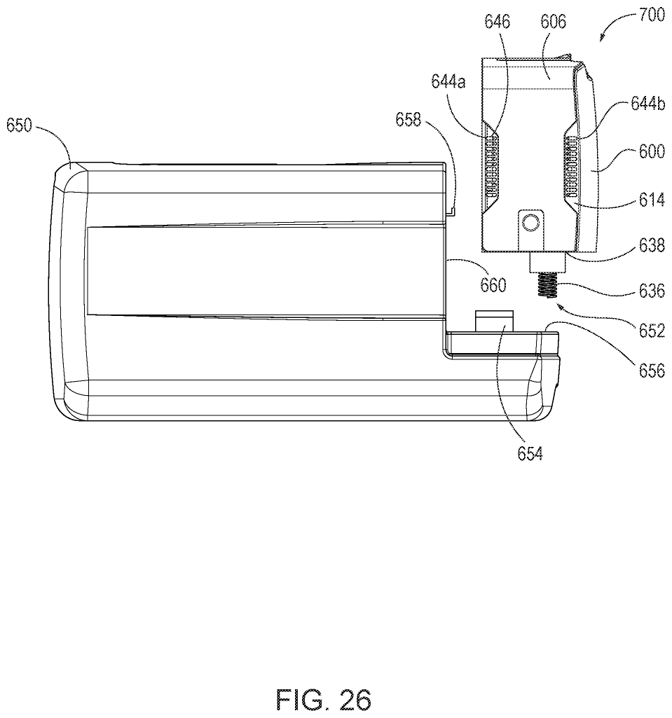

As shown in FIG. 26, the reservoir 650 includes a filtration unit receptacle 652 that is shaped and sized to receive the water filtration unit 600. In the depicted embodiment, the filtration unit receptacle 652 includes a reservoir outlet or outlet valve 654 on a recessed top wall 656 and a reservoir latch component 658 on a recessed front wall 660. The reservoir outlet valve 654 couples with or is biased against the inlet valve 636 of the water filtration unit 600 creating a fluid pathway between the reservoir 650 and the water filtration unit 600.

In operation, water flows from the reservoir 650, through the reservoir outlet valve 654, through the inlet valve 636, to the pump inlet 628 via the first connector 640a, through the pump 622, out the pump outlet 630 to the filter inlet 632 via the second connector 640b, through the filters 620a, b, out the filter outlet 634 and to the water dispenser via third connector 640c. In several embodiments, water flowing through the system prior to flowing through the filters 620a, b may be dirty water, and water flowing out the filter outlet 634 to the water dispenser is clean, filtered, drinking water.

As discussed above, it is contemplated that the water may flow through the filters 620a, b simultaneously or sequentially. As an example, the water may flow through the filter inlet 632, through the second filter 620b, through the first filter 620a, and out the filter outlet 634. In this example, the second filter 620b may filter certain toxins from the water so that the first filter 620a receives the water without the filtered toxins, improving the ability of the first filter 620a to filter additional toxins out of the water. The first filter 620a may filter the same or different toxins from the water, thereby improving water quality.

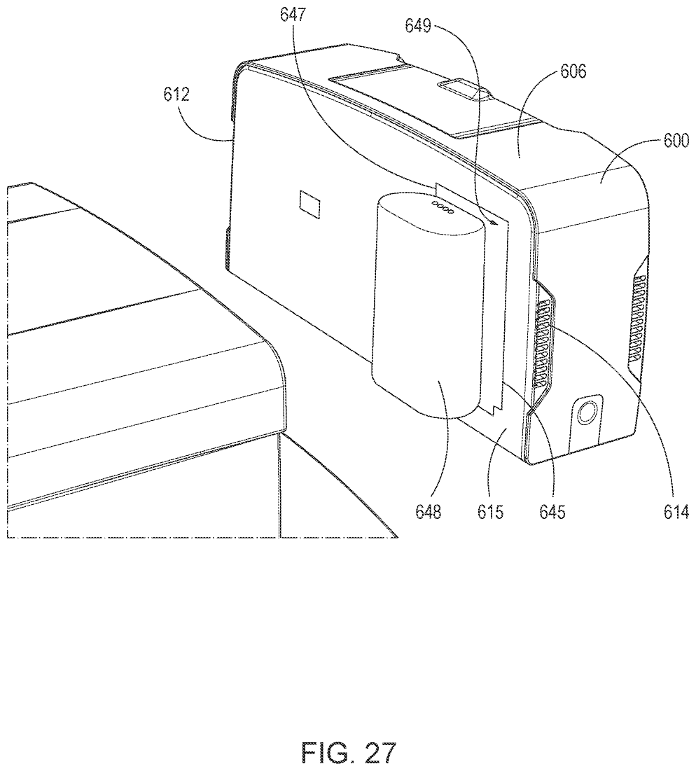

It is contemplated that the power source discussed with respect to the embodiment depicted in FIGS. 1-15 and associated ports (e.g., USB ports 142a, b) may be varied (e.g., by type, location on the filtration unit housing, etc.). For example, FIG. 26 shows a possible alternate location for a port. As shown, the filtration unit housing 606 includes vents 644a, b on the right sidewall 614. The vents 644a, b may provide access to a charging port 646 (e.g., a USB port), e.g., to charge an external device such as a mobile phone. FIG. 27 shows an alternate placement of a power source 648. As shown, the power source 648 may be positioned within a power port 647 defined within a rear wall 615 of the filtration unit housing 606. As shown, the power port 647 defines as substantially rectangular power port cavity 649 that corresponds with a shape of the power source 648. A longer power port edge 645 of the power port 647 is parallel to the left and right sidewalls 612, 614, such that the power port 647 is positioned vertically within the rear wall 615.

In some embodiments, the water filtration unit 100 may include additional or different water cleaning means than the one or more filters described above. As an example, the water filtration unit 100 may include an ozone generator stored within the filtration unit cavity 134 as an alternative to or in addition to the first and second filters 112a, b. An ozone generator can kill bacteria in water that passes therethrough. In embodiments including both the ozone generator and one or more filters, the water filtration unit 100 may include a selection mechanism (e.g., a button) for a user to select between the two options (e.g., an ozone option and a filter option), such that water either flows through the one or more filters or the ozone generator. Alternatively, water may flow through both the filters and ozone generator.

It is contemplated that the water filtration unit 100 may include a universal coupling means or fitting or fitting accessory to couple with any water cooler, reservoir, jug, storage container, source, etc. For example, the water filtration unit 100 may include a universal port or fitting that couples with one or more accessories configured to couple with different sized and shaped outlets (e.g., inlet valves, spouts, ports, openings, etc.) on various water sources/storage containers. As one example, the water filtration unit 100 may be coupled to any water storage container (e.g., a water jug) or water source (e.g., a river) by a hose or other tubing.

Although the present disclosure has been described with a certain degree of particularity, it is understood the disclosure has been made by way of example, and changes in detail or structure may be made without departing from the spirit of the disclosure as defined in the appended claims.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

We claim:

1. A water filtration unit, comprising:
a filtration unit housing defining a filtration unit cavity,
an inlet coupled to the filtration unit housing;
a pump positioned at least partially within the filtration unit cavity, the pump including a pump inlet and pump outlet, wherein the pump inlet is coupled to the inlet;
a filter housing positioned at least partially within the filtration unit cavity, the filter housing comprising a filter inlet and filter outlet, wherein the filter inlet is coupled to the pump outlet;
a water dispenser coupled to the filter outlet; and
a power source, wherein the power source is in communication with the pump to power the pump to push water through the filter housing when the water filtration unit is coupled to a water source.

2. The water filtration unit of claim 1, wherein the power source is a battery and the pump is a battery-powered pump.

3. The water filtration unit of claim 1, wherein the filter housing comprises a first and second filter housing unit configured to store a first and second filter.

4. The water filtration unit of claim 3, wherein water flows through the first filter before flowing through the second filter when the first and second filters are positioned in the first and second filter housing units and the pump is activated by the power source.

5. The water filtration unit of claim 1, wherein the pump operates at a pressure of less than 40 psi.

6. The water filtration unit of claim 1, wherein the pump is configured to push water through two nano filters stored in the filter housing at a flow rate that is sufficient to produce drinking water from river water.

7. The water filtration unit of claim 1, wherein
the filtration unit housing defines a water dispenser cavity;
the water dispenser is positioned in the water dispenser cavity; and
the water dispenser is removable from the water dispenser cavity to dispense water in a position apart from the filtration unit housing.

8. The water filtration unit of claim 7, further comprising a UV light positioned in the water dispenser cavity, wherein the UV light is configured to sanitize the water dispenser when the water dispenser is positioned in the water dispenser cavity.

9. The water filtration unit of claim 8, further comprising:
a lid hingedly connected to the filtration unit housing, the lid covering the water dispenser cavity;
a sensor coupled to the filtration unit housing; and
a processing element in communication with the sensor, wherein the processing element is configured to:
receive a signal from the sensor indicating that the lid is in a closed position,
activate the UV light and a timer based on the received signal, and
deactivate the UV light after a period of time.

10. The water filtration unit of claim 1, wherein the inlet is sized to couple to a reservoir outlet valve of a water reservoir, wherein the reservoir outlet valve is in a closed configuration when the reservoir outlet valve is not coupled to the inlet preventing water flow therethrough and in an open configuration when the reservoir outlet valve is coupled to the inlet allowing water from the water reservoir to flow therethrough.

11. The water filtration unit of claim 1, further comprising
a sensor coupled to the water dispenser, the sensor configured to detect flow through the water dispenser; and
a processing element in communication with the sensor, the processing element configured to:
receive a signal from the sensor indicative of flow through the water dispenser,
detect a no flow state through the water dispenser based on the received signal,
initiate a timer when the no flow state is detected, and
deactivate the pump after a predetermined amount of time has passed.

12. The water filtration unit of claim 1, wherein the filtration unit housing further comprises one or more ports for providing power to or receiving power from one or more external devices.

13. The water filtration unit of claim 1, wherein the filtration unit housing further comprises one or more indicators providing a status of one or more of filter health, water level, and battery life.

14. The water filtration unit of claim 1, wherein the power source is removable and rechargeable.

15. A water filtration unit for a dirty water reservoir comprising:
a water filtration unit housing defining a filtration unit cavity;
a pump positioned at least partially within the filtration unit cavity;
a power source in electrical communication with the pump;
a water dispenser coupled to an outer surface of the water filtration unit housing;
an inlet coupled to the water filtration unit housing and configured to couple to a reservoir outlet of the dirty water reservoir; and
a filter housing in fluid communication with the pump and the water dispenser and configured to house a filter,
wherein activation of the pump by the power source pulls dirty water from the dirty water reservoir when the inlet is coupled to the reservoir outlet and pushes the dirty water to the filter housing, wherein filtered water is pushed from the filter housing to the water dispenser by the activated pump when the filter is positioned within the filter housing.

16. The water filtration unit of claim 15, wherein the filter housing is further configured to house a second filter in fluid communication with the filter and the pump, wherein twice filtered water passes from the filter housing to the water dispenser when the filter and second filter are positioned within the filter housing.

17. The water filtration unit of claim 15, wherein the water filtration unit comprises a latch coupled to the outer surface of the water filtration unit housing and configured to couple the water filtration unit to the dirty water reservoir.

18. A water filtration reservoir comprising:
a reservoir, comprising:
a reservoir housing defining a reservoir cavity, and
a reservoir outlet coupled to the reservoir housing;
a water filtration unit coupled to the reservoir, the water filtration unit comprising:
a filtration unit housing defining a filtration unit cavity,
an inlet coupled to the filtration unit housing,
a pump positioned at least partially within the filtration unit cavity, the pump including a pump inlet and pump outlet, wherein the pump inlet is coupled to the inlet,
a filter housing positioned at least partially within the filtration unit cavity, the filter housing including a filter inlet and filter outlet, wherein the filter inlet is coupled to the pump outlet,
a water dispenser coupled to the filter outlet, and
a power source, wherein the power source is in communication with the pump to power the pump to push water through the filter housing from the reservoir;
wherein the water filtration unit is aligned with the reservoir such that the inlet is biased against the reservoir outlet, allowing water to flow from the reservoir to the water filtration unit when the pump is activated.

19. The water filtration reservoir of claim 18, wherein the reservoir further comprises a reservoir latch component coupled to the reservoir housing, and the water filtration unit further comprises a latch coupled to the filtration unit housing, wherein the latch is coupled to the reservoir latch component to secure the water filtration unit to the reservoir.

20. The water filtration reservoir of claim 18, wherein the reservoir is made of a nano silver embedded material.
